(19) United States
(12) Patent Application Publication
(10) Pub. No.: US 2025/0142632 A1
(43) Pub. Date: May 1, 2025

(54) WIRELESS COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventor: Chuanfeng HE, Dongguan (CN)

(21) Appl. No.: 19/003,239

(22) Filed: Dec. 27, 2024

Related U.S. Application Data
(63) Continuation of application No. PCT/CN2022/105093, filed on Jul. 12, 2022.

(51) Int. Cl. H04W 74/0833; H04L 1/00; H04L 5/00

(52) U.S. Cl. CPC H04W 74/0833; H04L 1/0003; H04L 5/0044

(57) ABSTRACT

A wireless communication method includes: determining, by a terminal device according to first information, an interpretation mode of a target modulation and coding scheme (MCS) information field and/or whether a random access procedure is applicable to repeated transmissions of a first physical uplink shared channel (PUSCH), where the first PUSCH is used to carry message 3 in the random access procedure, and the first information is related to repeated transmissions of a physical random access channel (PRACH) in the random access procedure.

### CROSS-REFERENCE TO RELATED APPLICATIONS

This application is a Continuation Application of International Application No. PCT/CN2022/105093 filed Jul. 12, 2022, which is incorporated herein by reference in its entirety.

### TECHNICAL FIELD

The present application relates to the field of communications, and in particular, to a wireless communication method, a terminal device and a network device.

### BACKGROUND

In a new radio (NR) system, a four-step random access procedure is supported, which includes a transmission process of message 1 (Msg1, i.e., physical random access channel (PRACH)) to message 4 (Msg4). Message 3 (Msg3) is carried in a physical uplink shared channel (PUSCH). In order to improve coverage performance of Msg3 PUSCH and PRACH, the introduction of repeated transmissions of Msg3 PUSCH and repeated transmissions of PRACH is considered. In this case, how to perform the repeated transmissions of the Msg3 PUSCH and repeated transmissions of the PRACH is an urgent problem to be solved.

### SUMMARY

In a first aspect, a wireless communication method is provided, which includes: determining, by a terminal device according to first information, an interpretation mode for a target modulation and coding scheme (MCS) information field and/or whether a random access procedure is applicable to repeated transmissions of a first physical uplink shared channel (PUSCH), where the first PUSCH is used to carry message 3 in the random access procedure, and the first information is related to repeated transmissions of a physical random access channel (PRACH) in the random access procedure.

In a second aspect, a wireless communication method is provided, which includes: determining, by a terminal device according to second information, whether a random access procedure is applicable to repeated transmissions of a physical random access channel (PRACH), where the second information is related to repeated transmissions of a first physical uplink shared channel (PUSCH) in the random access procedure, and the first PUSCH is used to carry message 3 in the random access procedure.

In a third aspect, a wireless communication method is provided, which includes: determining, by a network device according to third information, information carried in a target modulation and coding scheme (MCS) information field and/or whether a random access procedure is applicable to repeated transmissions of first physical uplink shared channel (PUSCH), where the first PUSCH is used to carry message 3 in the random access procedure, and the third information is related to repeated transmissions of a physical random access channel (PRACH) in the random access procedure.

In a fourth aspect, a terminal device is provided, which is configured to perform the method in the above first aspect or its various implementations.

Optionally, the terminal device includes a functional module configured to perform the method in any one of the first aspect and second aspect or their various implementations.

In a fifth aspect, a network device is provided, which is configured to perform the method in the above third aspect or its various implementations.

Optionally, the network device includes a functional module configured to perform the method in the above third aspect or its various implementations.

In a sixth aspect, a terminal device is provided, and the terminal device includes: a processor and a memory. The memory is configured to store a computer program, and the processor is configured to invoke and execute the computer program stored in the memory to cause the terminal device to perform the method in any one of the first aspect and second aspect or their various implementations.

In a seventh aspect, a network device is provided, and the network device includes: a processor and a memory. The memory is configured to store a computer program, and the processor is configured to invoke and execute the computer program stored in the memory to cause the network device to perform the method in the third aspect or its various implementations.

In an eighth aspect, a chip is provided, which is configured to implement the method in any one of the above first to third aspects or various implementations thereof. Optionally, the chip includes a processor, and the processor is configured to invoke and execute a computer program from a memory to cause a device equipped with the chip to perform the method in any one of the above first to third aspects or various implementations thereof.

In a ninth aspect, a non-transitory computer-readable storage medium is provided, which is configured to store a computer program. The computer program causes a computer to perform the method in any one of the above first to third aspects or various implementations thereof.

In a tenth aspect, a computer program product is provided, which includes computer program instructions. The computer program instructions cause a computer to perform the method in any one of the above first to third aspects or various implementations thereof.

In an eleventh aspect, a computer program is provided, and the computer program, when executed on a computer, causes the computer to perform the method in any one of the above first to second aspects or various implementations thereof.

### BRIEF DESCRIPTION OF THE DRAWINGS

FIG. 1 is a schematic diagram of a communication system architecture provided by the embodiments of the present application.

FIG. 2 is a schematic diagram illustrating a four-step random access procedure.

FIG. 3 is a schematic diagram illustrating repeated transmissions of PRACH.

FIG. 4 is a schematic flowchart of a wireless communication method provided according to the embodiments of the present application.

FIG. 5 is a schematic diagram illustrating repeated transmissions of Msg3 PUSCH and repeated transmissions of PRACH provided in the present application.

FIG. 6 is a schematic diagram illustrating a configuration mode of PRACH resources provided in the present application.

FIG. 7 is a schematic flowchart of another wireless communication method provided according to the embodiments of the present application.

FIG. 8 is a schematic flowchart of yet another wireless communication method provided according to the embodiments of the present application.

FIG. 9 is a schematic block diagram of a terminal device provided according to the embodiments of the present application.

FIG. 10 is a schematic block diagram of another terminal device provided according to the embodiments of the present application.

FIG. 11 is a schematic block diagram of a network device provided according to the embodiments of the present application.

FIG. 12 is a schematic block diagram of a communication device provided according to the embodiments of the present application.

FIG. 13 is a schematic block diagram of a chip provided according to the embodiments of the present application.

FIG. 14 is a schematic block diagram of a communication system provided according to the embodiments of the present application.

### DETAILED DESCRIPTION

Technical solutions in the embodiments of the present application will be described below with reference to the accompanying drawings of the embodiments of the present application. Obviously, the described embodiments are merely some but not all of the embodiments of the present application. All other embodiments obtained based on the embodiments of the present application by those ordinary skilled in the art shall be included in the protection scope of the present application.

The technical solutions of the embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial communication network (NTN) system, a universal mobile telecommunication system (UMTS), a wireless local area network (WLAN), a wireless fidelity (WiFi), a 5th-generation (5G) communication system, or other communication systems, etc.

Generally speaking, a number of connections supported by a traditional communication system is limited and is easy to implement. However, with the development of the communication technology, mobile communication system will not only support the traditional communication, but will also support, for example, device to device (D2D) communication, machine to machine (M2M) communication, machine type communication (MTC), vehicle to vehicle (V2V) communication, or vehicle to everything (V2X) communication, and the embodiments of the present application may also be applied to these communication systems.

Optionally, the communication system in the embodiments of the present application may be applied to a carrier aggregation (CA) scenario, may also be applied to a dual connectivity (DC) scenario, and may also be applied to a standalone (SA) network deployment scenario.

Optionally, the communication system in the embodiments of the present application may be applied to an unlicensed spectrum, where the unlicensed spectrum may also be considered as a shared spectrum; or the communication system in the embodiments of the present application may also be applied to a licensed spectrum, where the licensed spectrum may also be considered as an unshared spectrum.

The embodiments of the present application describe various embodiments in conjunction with a network device and a terminal device, where the terminal device may also be referred to as a user equipment (UE), an access terminal, a user unit, a user station, a mobile station, a mobile console, a remote station, a remote terminal, a mobile device, a user terminal, a terminal, a wireless communication device, a user agent or a user apparatus, or the like.

The terminal device may be a station (STA) in the WLAN, which may be a cellular phone, a cordless phone, a session initiation protocol (SIP) phone, a wireless local loop (WLL) station, a personal digital assistant (PDA) device, a handheld device with a wireless communication function, a computing device or other processing devices connected to a wireless modem, a vehicle-mounted device, a wearable device, a terminal device in a next-generation communication system (such as in an NR network), a terminal device in a public land mobile network (PLMN) network evolved in the future, or the like.

In the embodiments of the present application, the terminal device may be deployed on land, which includes indoor or outdoor, in handheld, worn or vehicle-mounted, which may also be deployed on water (e.g., on a ship), and may also be deployed in the air (e.g., on an airplane, a balloon, and a satellite).

In the embodiments of the present application, the terminal device may be a mobile phone, a pad, a computer with a wireless transceiving function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like.

As an example but not a limitation, in the embodiments of the present application, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the application, the network device may be a device used for communicating with a mobile device. The network device may be an access point (AP) in the WLAN, a base station (BTS) in the GSM or CDMA, which may also be a base station (NodeB, NB) in the WCDMA, and may also be an evolutional base station (Evolutional Node B, eNB or eNodeB) in the LTE, a relay station or access point, a vehicle-mounted device, a wearable device, a network device (gNB) in an NR network, a network device in the PLMN network evolved in the future or a network device in the NTN network, or the like.

As an example but not a limitation, in the embodiments of the present application, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite. Optionally, the network device may also be a base station provided on land, water, and other places.

In the embodiments of the present application, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and small cells here may include: a metro cell, a micro cell, a pico cell, a femto cell, etc, these small cells have features of a small coverage range and a low transmit power, which are applicable for providing a data transmission service with high speed.

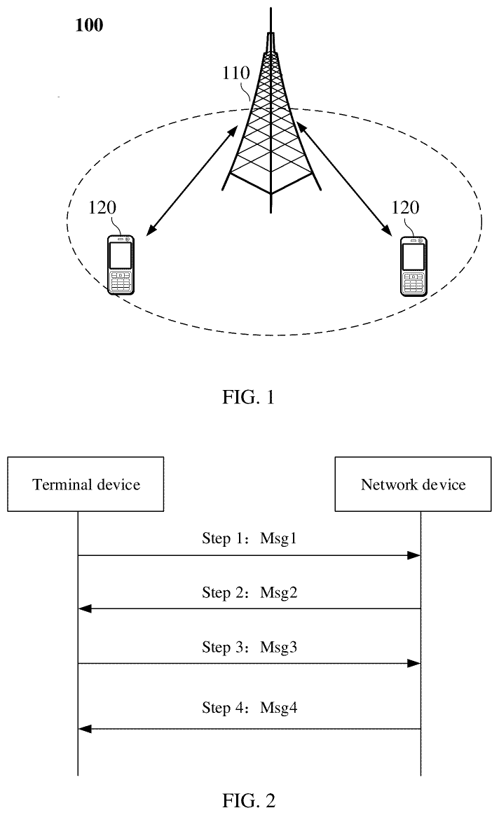

Exemplarily, the communication system 100 applied by the embodiments of the present application is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily shows one network device and two terminal devices, and optionally, the communication system 100 may include a plurality of network devices and may include another number of terminal devices within a coverage range of each network device, the embodiments of the present application are not limited thereto.

Optionally, the communication system 100 may further include other network entities such as a network controller and a mobility management entity, which are not limited to the embodiments of the present application.

It should be understood that, in the embodiments of the present application, a device with a communication function in the network/system may be referred to as a communication device. Taking the communication system 100 shown in FIG. 1 as an example, communication devices may include the network device 110 and the terminal device 120 with the communication function, and the network device 110 and the terminal device 120 may be the specific devices described above, which will not be repeated herein; the communication devices may further include other devices in the communication system 100, such as a network controller, a mobility management entity, and other network entities, which are not limited in the embodiments of the present application.

It should be understood that the terms “system” and “network” are often used interchangeably herein. Herein, the term “and/or” is only an association relationship to describe associated objects, which means that there may be three kinds of relationships. For example, A and/or B may represent three cases that: A exists alone, both A and B exist, and B exists alone. In addition, a character “/” herein generally means that related objects before and after “/” are in an “or” relationship.

It should be understood that “indicate” mentioned in the embodiments of the present application may mean a direct indication, may mean an indirect indication, or may represent that there is an association relationship. For example, A indicates B, which may mean that A directly indicates B (for example, B may be obtained by A) or may mean that A indirectly indicates B (for example, A indicates C, and B may be obtained by C), or may mean that there is an association relationship between A and B.

In the description of the embodiments of the present application, the term “correspond” may mean that there is a direct correspondence or indirect correspondence between two, or it may mean that there is an associated relationship between the two, or it may mean a relationship of indicating and being indicated or a relationship of configuring and being configured, etc.

In the embodiments of the present application, “predefined” may be implemented by pre-saving corresponding codes, tables or other manners that may be used for indicating related information, in the device (for example, including the terminal device and the network device), and the present application does not limit its implementation. For example, the predefined may refer to what is defined in a protocol.

In the embodiments of the present application, the “protocol” may refer to a standard protocol in the field of communication, which may include, for example, an LTE protocol, an NR protocol, and related protocols applied in the future communication system, and the present application is not limited thereto.

To facilitate the understanding of the technical solutions in the embodiments of the present application, the technical solutions of the present application will be described in detail below through embodiments. The above technologies, as optional solutions, may be arbitrarily combined with the technical solutions of the embodiments of the present application, and those combined solutions all fall within the protection scope of the embodiments of the present application. The embodiments of the present application include at least a part of the following contents.

In an NR system, a four-step random access procedure is supported, which includes the transmission process of message 1 (Msg1) to message 4 (Msg4). As an example, as shown in FIG. 2, the four-step random access procedure includes the following steps.

In Step 1, the terminal device transmits a random access preamble (i.e., Msg1) to the network device.

Here, the random access preamble may also be called a preamble, a random access preamble sequence, a preamble sequence, or the like.

Optionally, the terminal device may select a physical random access channel (PRACH) resource, and the PRACH resource may include a time domain resource, a frequency domain resource, and a code domain resource. The network device transmits random access related parameters to the terminal device by broadcasting system information block (SIB) 1, in which a reference signal receiving power (RSRP) threshold value for synchronization signal blocks (SSBs) (rsrp-ThresholdSSB) in a random access common configuration information element (RACH-ConfigCommon IE) is used by the terminal device to select SSB. The terminal device compares the RSRP measurement result under each SSB with the rsrp-ThresholdSSB, and selects the SSB with a measurement value greater than the configured threshold value for access. If no SSB satisfies the configured threshold value, one SSB is randomly selected from all SSBs for access.

Each SSB corresponds to a set of random access preamble resources and random access occasion (RO) resources. The terminal device performs a random selection in contention-based random access resources in a selected SSB and sets a selected random access preamble as a preamble index (PREAMBLE_INDEX). The network device may estimate a transmission delay between itself and the terminal device according to the preamble and calibrates an uplink timing according to the transmission delay, and may roughly determine a size of resources required by the terminal device for Msg3 transmission. In order to allow the network device to more accurately know a size of Msg3 to be transmitted so as to allocate appropriate uplink resources, preambles are divided into preamble group A and preamble group B. If preamble group B exists in random access resources, the terminal device may select the preamble group according to the size of Msg3 and pathloss.

In Step 2, the network device transmits a random access response (RAR, i.e., Msg2) to the terminal device.

After transmitting the preamble to the network device, the terminal device may initiate a random access response window (ra-ResponseWindow) and detect a corresponding physical downlink control channel (PDCCH) within the ra-Respons Window according to a random access radio network temporary identifier (RA-RNTI). If the terminal device detects a RA-RNTI-scrambled PDCCH, the terminal device may obtain a physical downlink shared channel (PDSCH) scheduled by the PDCCH. The PDSCH includes the RAR corresponding to the preamble.

RA-RNTI is calculated according to a time-frequency location of a PRACH transmitting the preamble. Therefore, if multiple terminal devices transmit preambles in the same RO, the corresponding RARs are multiplexed in the same RAR media access control protocol data unit (MAC PDU). If the terminal successfully receives a PDCCH scrambled by the RA-RNTI corresponding to the RO resource transmitting the preamble, and the RAR contains a MAC subPDU and a random access sequence identifier (RAPID) carried by the MAC subPDU is corresponding to a PREAMBLE_INDEX selected in the above Msg1, the RAR is received successfully. In this way, the terminal may obtain a timing advance command (TAC), uplink grant resources (UL Grant) and temporary cell RNTI (TC-RNTI) by decoding, and proceed to Msg3.

If the PDCCH scrambled by the RA-RNTI corresponding to the RO resource transmitting the preamble is not received during the operation of the ra-ResponseWindow, or the RA-RNTI-scrambled PDCCH is received, but the RAR does not contain a MAC subPDU corresponding to the PREAMBLE_INDEX, in the above two cases, it is considered that the RAR reception fails. In this case, if the transmission number of the preamble does not exceed the maximum transmission number (preambleTransMax) configured by the network, the terminal device needs to retransmit Msg1. If the transmission number of the preamble exceeds the maximum transmission number (preambleTransMax) configured by the network, the terminal device reports a random access problem to the upper layer.

In Step 3, the terminal device transmits Msg3.

After receiving the RAR message, the terminal device determines whether the RAR is a RAR message returned to the terminal device. For example, the terminal device may use the preamble index for checking. After determining that the RAR is a RAR message returned to the terminal device, the terminal device may generate Msg3 at the RRC layer and transmit Msg3 to the network device, in which identification information of the terminal device needs to be carried.

Here, Msg3 is mainly used to notify the network device of the triggering event of the random access. For different random access triggering events, Msg3 transmitted by the terminal device in Step 3 may include different contents.

For example, for an initial access scenario, Msg3 may include an RRC connection request message (RRC Setup Request) generated by the RRC layer. In addition, Msg3 may further carry, for example, a 5G serving-temporary mobile subscriber identity (S-TMSI) of the terminal device or a random number.

In another example, for a RRC connection reestablishment scenario, Msg3 may include an RRC connection reestablishment request message (RRC Reestabilshment Request) generated by the RRC layer. In addition, Msg3 may further carry, for example, a cell radio network temporary identifier (C-RNTI).

In another example, for a handover scenario, Msg3 may include a RRC handover confirm message generated by the RRC layer, which carries the C-RNTI of the terminal device. In addition, Msg3 may further carry information such as a buffer status report (BSR). For other triggering events such as the arrival of uplink/downlink data, Msg3 may at least include the C-RNTI of the terminal device.

In Step 4, the network device transmits a contention resolution message, i.e., Msg4, to the terminal device.

The network device transmits Msg4 to the terminal device, and the terminal device correctly receives Msg4 to complete contention resolution. For example, during the RRC connection establishment process, Msg4 may carry a RRC connection establishment message.

Msg3 is carried in a physical uplink shared channel (PUSCH), and the RAR included in Msg2 carries an UL grant of a PUSCH used for the initial transmission of Msg3. The UL grant carried in the RAR is called the RAR UL grant. The information carried by the RAR UL grant information may include time domain and frequency domain resource allocation information of PUSCH, power control command TPC, frequency hopping, MCS, or the like.

If the network device does not receive Msg3 correctly, it will indicate scheduling information for retransmission of Msg3 via DCI, for example, via a DCI format 0_0 scrambled by a temporary cell radio network temporary identity (TC-RNTI). In addition to the content contained in the RAR UL grant, Msg2 further includes a new data indicator (NDI), redundancy version, and a HARQ process number.

In order to improve the coverage performance of Msg3 PUSCH, repeated transmissions of the Msg3 PUSCH is introduced, and the base station needs to indicate the number of repeated transmissions of Msg3 PUSCH. For repeated transmissions of Msg3 PUSCH, the selection of the size of Msg3 is limited and the repeated transmissions of Msg3 PUSCH is used for coverage enhancement scenarios, thus the MCS level used for Msg3 PUSCH transmission is also limited. Therefore, it is considered to use a portion of bits in the MCS information field to indicate the number of repeated transmissions of Msg3 PUSCH.

For the initial transmission of Msg3 PUSCH scheduled by the RAR UL grant, the number of repeated transmissions is indicated by the 2 most significant bits in the MCS information field in the RAR UL grant. The 2 least significant bits in the MCS information field are used to indicate a MCS index, which is one of 4 types of MCS indexes. Here, a candidate number of repeated transmissions indicated by the 2 most significant bits in the MCS information field may be configured by the network device in a system message. If the network device does not configure the candidate number of repeated transmissions, a default candidate number of repeated transmissions may be one of {1, 2, 3, 4}. A mapping relationship between the value of the 2 most significant bits in the MCS information field and an indicated number of repeated transmissions K for Msg3 PUSCH is shown in Table 1 below, where a high-level parameter (i.e., NumofMsg3Repetition) is used to configure 4 types of candidate number of repeated transmissions.

TABLE 1

| NumofMsg3Repetition | | NumofMsg3Repetition | |
|---|---|---|---|
| is configured | | is not configured | |
| Codepoint | K | Codepoint | K |
| 00 | The first value in | 00 | 1 |
| | NumofMsg3Repetition | | |
| 01 | The second value in | 01 | 2 |
| | NumofMsg3Repetition | | |
| 10 | The third value in | 10 | 3 |
| | NumofMsg3Repetition | | |
| 11 | The fourth value in | 11 | 4 |
| | NumofMsg3Repetition | | |

The 2 least significant bits in the MCS information field are used to indicate one of the 4 types of MCS indexes, and the 4 types of MCS indexes are configured by the network device through the high-level parameter mcs-Msg3Repetition. If mcs-Msg3Repetition is not configured, the 4 types of MCS indexes take default values 0 to 3, respectively. The correspondence between values of the 2-bit LSB and the indicated 4 types of MCS indexes is shown in Table 2 below.

TABLE 2

| mcs-Msg3Repetition | | mcs-Msg3Repetitions | |
|---|---|---|---|
| is configured | | is not configured | |
| Codepoint | IMCS | Codepoint | IMCS |
| 00 | The first value in mcs- | 00 | 0 |
| | Msg3Repetition | | |
| 01 | The second value in mcs- | 01 | 1 |
| | Msg3Repetition | | |
| 10 | The third value in mcs- | 10 | 2 |
| | Msg3Repetition | | |
| 11 | The fourth value in mcs- | 11 | 3 |
| | Msg3Repetition | | |

For the retransmission of Msg3, scheduling information for Msg3 PUSCH is carried in a DCI format 0_0 with CRC scrambled by a TC-RNTI. The scheduling information includes a 5-bit MCS information field, and the 2 most significant bits may indicate one in a set consisting of four types of number of repeated transmissions. The 3 least significant bits are used to indicate the MCS index, and in this case, can indicate eight types of MCS indexes. The eight types of MCS indexes are configured by network devices through the parameter mcs-Msg3Repetition. If mcs-Msg3Repetition is not configured, the eight types of MCS indexes take default values 0 to 7, respectively. Table 3 shows the mapping relationship between MCS indexes and the 3 least significant bits in the MCS information field in a DCI format 0_0 with CRC scrambled by a TC-RNTI.

TABLE 3

| mcs-Msg3Repetition | | mcs-Msg3Repetitions | |
|---|---|---|---|
| is configured | | is not configured | |
| Codepoint | IMCS | Codepoint | IMCS |
| 000 | The first value in mcs- | 000 | 0 |
| | Msg3Repetition | | |
| 001 | The second value in mcs- | 001 | 1 |
| | Msg3Repetition | | |
| 010 | The third value in mcs- | 010 | 2 |
| | Msg3Repetition | | |
| 011 | The fourth value in mcs- | 011 | 3 |
| | Msg3Repetition | | |
| 100 | The fifth value in mcs- | 100 | 4 |
| | Msg3Repetition | | |
| 101 | The sixth value in mcs- | 101 | 5 |
| | Msg3Repetition | | |
| 110 | The seventh value in mcs- | 110 | 6 |
| | Msg3Repetition | | |
| 111 | The eighth value in mcs- | 111 | 7 |
| | Msg3Repetition | | |

During a random access procedure, after transmitting a PRACH, UE receives a RAR transmitted by the network within a RAR receiving window. If UE does not receive the RAR, it will transmit the PRACH again on the next available PRACH resource and increase the power of the PRACH by one step.

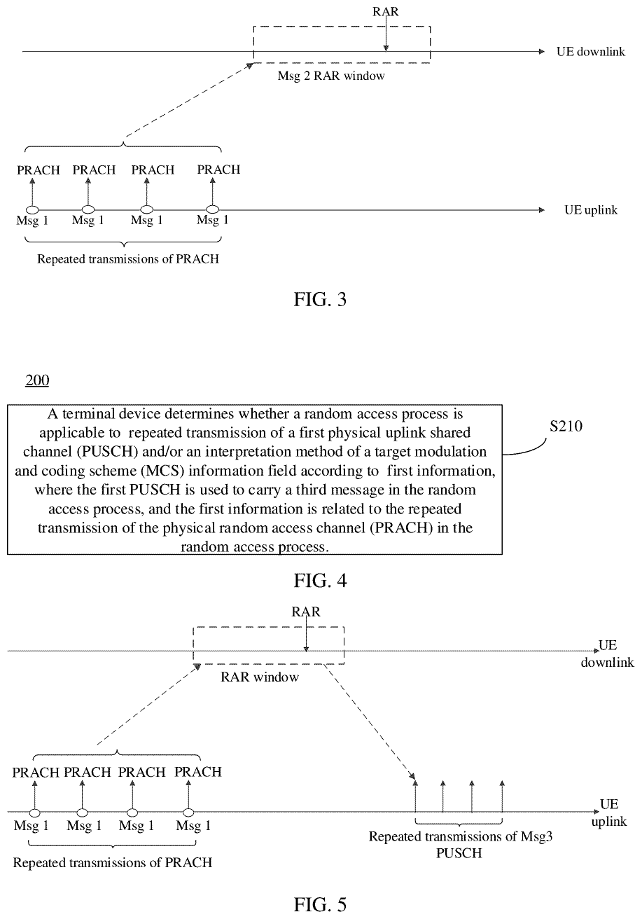

However, in the case of a limited coverage, UE cannot increase the power of the PRACH infinitely to allow itself to be detected by the network device. In order to improve the coverage performance of PRACH, it is considered to introduce repeated transmissions of PRACH. As shown in FIG. 3, repeated transmissions of the PRACH all correspond to the same RAR receiving window, and thus the network device can perform a combined reception for the repeated transmissions of the PRACH to improve detection performance, thereby improving the coverage of PRACH. In this case, how to perform repeated transmissions of Msg3 PUSCH and repeated transmissions of PRACH is an urgent issue that needs to be solved.

Embodiments of this application provide a wireless communication method. The method includes:
determining, by a terminal device according to first information, an interpretation mode for a target modulation and coding scheme (MCS) information field and/or whether a random access procedure is applicable to repeated transmissions of a first physical uplink shared channel (PUSCH), where the first PUSCH is used to carry message 3 in the random access procedure, and the first information is related to repeated transmissions of a physical random access channel (PRACH) in the random access procedure.

In some embodiments of the application, the first information includes a random access response (RAR) in the random access procedure and whether the random access procedure is applicable to repeated transmissions of the PRACH.

In some embodiments of the application, determining, by the terminal device according to the first information, the interpretation mode for the target modulation and coding scheme (MCS) information field and/or whether the random access procedure is applicable to repeated transmissions of the first physical uplink shared channel (PUSCH) includes:
determining, by the terminal device according to the first information, the interpretation mode for the target modulation and coding scheme (MCS) information field and/or whether to request repeated transmissions of the first physical uplink shared channel (PUSCH).

In some embodiments of the application, determining, by the terminal device according to the first information, whether to request repeated transmissions of the first physical uplink shared channel (PUSCH) includes: determining to request repeated transmissions of the first PUSCH, in a case where the random access procedure is applicable to repeated transmissions of the PRACH; or determining not to request repeated transmissions of the first PUSCH, in a case where the random access procedure is not applicable to repeated transmissions of the PRACH.

In some embodiments of the application, determining, by the terminal device according to the first information, the interpretation mode for the target modulation and coding scheme (MCS) information field includes:
determining the number of repeated transmissions of the first PUSCH according to the target MCS information field, in a case where the random access procedure is applicable to repeated transmissions of the PRACH.

In some embodiments of the application, determining, by the terminal device according to the first information, the interpretation mode for the target modulation and coding scheme (MCS) information field and/or whether the random access procedure is applicable to repeated transmissions of the first physical uplink shared channel (PUSCH) includes:
determining, according to the RAR, the interpretation mode for the target MCS information field and/or whether to perform repeated transmissions of the first PUSCH, in a case where the random access procedure is applicable to repeated transmissions of the PRACH.

In some embodiments of the application, the RAR includes first indication information, the first indication information is used to determine a target preamble, and the target preamble is a preamble transmitted in repeated transmissions of the PRACH.

In some embodiments of the application, the first indication information is used to indicate at least one of:
index information of the target preamble;
a random access radio network temporary identifier (RA-RNTI) of a physical downlink control channel (PDCCH), where the RA-RNTI is determined according to a resource location on which the target preamble is located, and the PDCCH is used to schedule the RAR;
a PRACH occasion in which the target preamble is located;
number information of the target preamble in a plurality of preambles, where the plurality of preambles are preambles transmitted in repeated transmissions of the PRACH; or
a transmission order number corresponding to a transmission of the target preamble in repeated transmissions of the PRACH.

In some embodiments of the application, determining, according to the RAR, the interpretation mode for the target MCS information field and/or whether to perform repeated transmissions of the first PUSCH includes:
determining, according to a number of a transmission of the target preamble in repeated transmissions of the PRACH, the interpretation mode for the target MCS information field and/or whether to perform repeated transmissions of the first PUSCH.

In some embodiments of the application, determining, according to the number of the transmission of the target preamble in repeated transmissions of the PRACH, whether to perform repeated transmissions of the first PUSCH includes:
determining to perform repeated transmissions of the first PUSCH, if the number of the transmission of the target preamble in repeated transmissions of the PRACH satisfies a first threshold; or
determining not to perform repeated transmissions of the first PUSCH, if the number of the transmission of the target preamble in repeated transmissions of the PRACH does not satisfy the first threshold.

In some embodiments of the application, determining, according to the number of the transmission of the target preamble in repeated transmissions of the PRACH, the interpretation mode for the target MCS information field includes:
determining the number of repeated transmissions of the first PUSCH according to the target MCS information field, if the number of the transmission of the target preamble in repeated transmissions of the PRACH satisfies a first threshold.

In some embodiments of the application, the number of repeated transmissions of the first PUSCH is determined according to a number of a transmission of the target preamble in repeated transmissions of the PRACH.

In some embodiments of the application, the method further includes determining whether the random access procedure is applicable to repeated transmissions of the PRACH according to a measurement result of a downlink signal.

In some embodiments of the application, determining whether the random access procedure is applicable to repeated transmissions of the PRACH according to the measurement result of the downlink signal includes:
determining that the random access procedure is applicable to repeated transmissions of the PRACH, in a case where the measurement result of the downlink signal satisfies a second threshold; or
determining that the random access procedure is not applicable to repeated transmissions of the PRACH, in a case where the measurement result of the downlink signal does not satisfy the second threshold.

In some embodiments of the application, the method further includes:
determining the number of repeated transmissions of the PRACH according to a measurement result of a downlink signal and a plurality of measurement result ranges, where the plurality of measurement result ranges respectively correspond to different quantities of repeated transmissions of the PRACH, and the plurality of measurement result ranges are determined according to a plurality of thresholds.

In some embodiments of the application, in a case where the terminal device adopts repeated transmissions of the PRACH and requests repeated transmissions of the first PUSCH, the PRACH is transmitted via a first PRACH resource, the first PRACH resource belongs to a first PRACH resource set, and the first PRACH resource set is associated with repeated transmissions of the PRACH and repeated transmissions of the first PUSCH.

In some embodiments of the application, in a case where the terminal device adopts repeated transmissions of the PRACH and does not request repeated transmissions of the first PUSCH, the PRACH is transmitted via a second PRACH resource, the second PRACH resource belongs to a second PRACH resource set, and the second PRACH resource set is associated with repeated transmissions of the PRACH.

In some embodiments of the application, in a case where the terminal device does not adopt repeated transmissions of the PRACH and requests repeated transmissions of the first PUSCH, the PRACH is transmitted via a third PRACH resource, the third PRACH resource belongs to a third PRACH resource set, and the third PRACH resource set is associated with repeated transmissions of the first PUSCH.

In some embodiments of the application, the target MCS information field is an MCS information field in an uplink grant of a RAR corresponding to the PRACH; or the target MCS information field is an MCS information field carried by a downlink control information (DCI) format 0_0 scrambled by a temporary cell radio network temporary identifier (TC-RNTI).

Embodiments of this application provide a wireless communication method. The method includes:
determining, by a terminal device according to second information, whether a random access procedure is applicable to repeated transmissions of a physical random access channel (PRACH), where the second information is related to repeated transmissions of a first physical uplink shared channel (PUSCH) in the random access procedure, and the first PUSCH is used to carry message 3 in the random access procedure.

In some embodiments of the application, the second information includes whether a condition for requesting repeated transmissions of the first PUSCH is satisfied.

In some embodiments of the application, determining, by the terminal device according to the second information, whether the random access procedure is applicable to repeated transmissions of a physical random access channel (PRACH) includes:
determining that the random access procedure is applicable to repeated transmissions of the PRACH, in a case where the condition for requesting repeated transmissions of the first PUSCH is satisfied; or
determining that the random access procedure is not applicable to repeated transmissions of the PRACH, in a case where the condition for requesting repeated transmissions of the first PUSCH is not satisfied.

In some embodiments of the application, the method further includes:
determining, by the terminal device, whether a condition for requesting repeated transmissions of the first PUSCH is satisfied according to a measurement result of a downlink signal.

In some embodiments of the application, determining, by the terminal device, whether the condition for requesting repeated transmissions of the first PUSCH is satisfied according to the measurement result of the downlink signal includes:
determining that the condition for requesting repeated transmissions of the first PUSCH is satisfied, in a case where the measurement result of the downlink signal satisfies a third threshold; or
determining that the condition for requesting repeated transmissions of the first PUSCH is not satisfied, in a case where the measurement result of the downlink signal does not satisfy the third threshold.

In some embodiments of the application, the number of repeated transmissions of the PRACH is configured by a network device or is predefined.

In some embodiments of the application, in a case where the terminal device adopts repeated transmissions of the PRACH and requests repeated transmissions of the first PUSCH, the PRACH is transmitted via a first PRACH resource, the first PRACH resource belongs to a first PRACH resource set, and the first PRACH resource set is associated with repeated transmissions of the PRACH and repeated transmissions of the first PUSCH.

In some embodiments of the application, in a case where the terminal device adopts repeated transmissions of the PRACH and does not request repeated transmissions of the first PUSCH, the PRACH is transmitted via a second PRACH resource, the second PRACH resource belongs to a second PRACH resource set, and the second PRACH resource set is associated with repeated transmissions of the PRACH.

In some embodiments of the application, where in a case where the terminal device does not adopt repeated transmissions of the PRACH and requests repeated transmissions of the first PUSCH, the PRACH is transmitted via a third PRACH resource, the third PRACH resource belongs to a third PRACH resource set, and the third PRACH resource set is associated with repeated transmissions of the first PUSCH.

Embodiments of this application provide a wireless communication method. The method includes:
determining, by a network device according to third information, information carried in a target modulation and coding scheme (MCS) information field and/or whether a random access procedure is applicable to repeated transmissions of a first physical uplink shared channel (PUSCH), where the first PUSCH is used to carry message 3 in the random access procedure, and the third information is related to repeated transmissions of a physical random access channel (PRACH) in the random access procedure.

In some embodiments of the application, the third information includes a target preamble transmitted in repeated transmissions of the PRACH and/or whether a terminal device adopts repeated transmissions of the PRACH.

In some embodiments of the application, determining, by the network device according to the third information, the information carried in the target modulation and coding scheme (MCS) information field and/or whether the random access procedure is applicable to repeated transmissions of the first physical uplink shared channel (PUSCH) includes:
determining, according to whether the terminal device adopts repeated transmissions of the PRACH, the information carried in the target MCS information field and/or whether the terminal device requests repeated transmissions of the first PUSCH.

In some embodiments of the application, determining, according to whether the terminal device adopts repeated transmissions of the PRACH, whether the terminal device requests repeated transmissions of the first PUSCH includes:
determining that the terminal device requests repeated transmissions of the first PUSCH, in a case where the terminal device adopts repeated transmissions of the PRACH; or
determining that the terminal device does not request repeated transmissions of the first PUSCH, in a case where the terminal device does not adopt repeated transmissions of the PRACH.

In some embodiments of the application, determining, according to whether the terminal device adopts repeated transmissions of the PRACH, the information carried in the target MCS information field includes:
determining information on the number of repeated transmissions of the first PUSCH carried in the target MCS information field, in a case where the terminal device adopts repeated transmissions of PRACH.

In some embodiments of the application, determining, by the network device according to the third information, the information carried in the target modulation and coding scheme (MCS) information field and/or whether the random access procedure is applicable to repeated transmissions of the first physical uplink shared channel (PUSCH) includes:
determining, according to the target preamble transmitted in repeated transmissions of the PRACH, the information carried in the target MCS information field and/or whether the random access procedure is applicable to repeated transmissions of the first PUSCH, in a case where the terminal device adopts repeated transmissions of the PRACH.

In some embodiments of the application, determining, according to the target preamble transmitted in repeated transmissions of the PRACH, the information carried in the target MCS information field and/or whether the random access procedure is applicable to repeated transmissions of the first PUSCH includes:
determining, according to a number of a transmission of the target preamble in repeated transmissions of the PRACH, the information carried in the target MCS information field and/or whether the random access procedure is applicable to repeated transmissions of the first PUSCH.

In some embodiments of the application, determining, according to the number of the transmission of the target preamble in repeated transmissions of the PRACH, the information carried in the target MCS information field and/or whether the random access procedure is applicable to repeated transmissions of the first PUSCH includes:
determining that the random access procedure is applicable to repeated transmissions of the first PUSCH, if the number of the transmission of the target preamble in repeated transmissions of the PRACH satisfies a first threshold; or
determining that the random access procedure is not applicable to repeated transmissions of the first PUSCH, if the number of the transmission of the target preamble in repeated transmissions of the PRACH does not satisfy the first threshold.

In some embodiments of the application, the method further includes:
transmitting, by the network device, a random access response (RAR) to the terminal device, where the RAR includes first indication information, the first indication information is used to determine the target preamble, and the first indication information is used by the terminal device to determine whether to perform repeated transmissions of the first PUSCH.

In some embodiments of the application, the first indication information is used to indicate at least one of:
index information of the target preamble;
number information of the target preamble in a plurality of preambles, where the plurality of preambles are preambles transmitted in repeated transmissions of the PRACH;
a random access radio network temporary identifier (RA-RNTI) of a physical downlink control channel (PDCCH), where the RA-RNTI is determined according to a resource location on which the target preamble is located, and the PDCCH is used to schedule the RAR;
a PRACH occasion in which the target preamble is located; or
a transmission order number corresponding to a transmission of the target preamble in repeated transmissions of the PRACH.

In some embodiments of the application, determining, according to the number of the transmission of the target preamble in repeated transmissions of the PRACH, the information carried in the target MCS information field includes:
determining information on the number of repeated transmissions of the first PUSCH that is carried in the target MCS information field, if the number of the transmission of the target preamble in repeated transmissions of the PRACH satisfies a first threshold.

In some embodiments of the application, the number of the transmission of the target preamble in repeated transmissions of the PRACH is further used to determine the number of repeated transmissions of the first PUSCH.

In some embodiments of the application, the method further includes:
determining, according to a PRACH resource used by the terminal device for transmitting the PRACH, whether the terminal device adopts repeated transmissions of the PRACH.

In some embodiments of the application, the method further includes:
transmitting, by the network device, first configuration information to the terminal device, where the first configuration information is used to configure a target PRACH resource set, and the target PRACH resource set is associated with repeated transmissions of the PRACH and/or repeated transmissions of the first PUSCH.

In some embodiments of the application, the target PRACH resource set includes at least one of:
a first PRACH resource set, associated with repeated transmissions of the PRACH and repeated transmissions of the first PUSCH;
a second PRACH resource set, associated with repeated transmissions of the PRACH; or a third PRACH resource set, associated with repeated transmissions of the first PUSCH.

FIG. 4 is a schematic flowchart of a wireless communication method 200 according to the embodiments of the present application. As shown in FIG. 4, the method 200 includes at least part of the following contents.

In S210, a terminal device determines, according to first information, an interpretation mode of a target modulation and coding scheme (MCS) information field and/or whether a random access procedure is applicable to repeated transmissions of a first physical uplink shared channel (PUSCH), where the first PUSCH is used to carry message 3 (i.e., Msg3) in the random access procedure, and the first information is related to repeated transmissions of the physical random access channel (PRACH) in the random access procedure.

In some embodiments, the terminal device supports repeated transmissions of PRACH and repeated transmissions of Msg3 PUSCH simultaneously.

In the embodiments of the present application, a PUSCH for carrying Msg3 may also be referred to as a Msg3 PUSCH. That is, the first PUSCH is the Msg3 PUSCH.

In some embodiments, whether the random access procedure is applicable to repeated transmissions of the Msg3 PUSCH may refer to:
whether repeated transmissions of the Msg3 PUSCH is required in the random access procedure, or whether there is a need for repeated transmissions of the Msg3 PUSCH.

In some embodiments, the terminal device determining whether the random access procedure is applicable to repeated transmissions of the Msg3 PUSCH may include at least one of:
the terminal device determining whether to request repeated transmissions of the Msg3 PUSCH, or the terminal device determining whether to perform (or adopt) repeated transmissions of the Msg3 PUSCH.

In some embodiments, in two cases where the random access procedure is applicable or not applicable to repeated transmissions of the Msg3 PUSCH, a target MCS information field corresponds to different interpretation modes.

For example, in the case where the random access procedure is applicable to repeated transmissions of the Msg3 PUSCH, the target MCS information field is used to indicate the number of repeated transmissions of the Msg3 PUSCH.

In some embodiments, the target MCS information field may be a MCS information field in a RAR UL grant. For example, in the case where the random access procedure is applicable to repeated transmissions of the Msg3 PUSCH, the number of repeated transmissions of the Msg3 PUSCH is indicated by the 2 most significant bits in the MCS information field.

In some other embodiments, the target MCS information field may be a MCS information field carried by a DCI format 0_0 scrambled by a TC-RNTI. For example, in the case where the random access procedure is applicable to repeated transmissions of the Msg3 PUSCH, the number of repeated transmissions of the Msg3 PUSCH is indicated by the 2 most significant bits in the MCS information field.

It should be understood that in the embodiments of the present application, the first information may refer to any information related to repeated transmissions of a PRACH, such as whether a random access procedure is applicable to repeated transmissions of the PRACH, whether the terminal device adopts repeated transmissions of the PRACH, whether a condition for repeated transmissions of the PRACH is met, a determination threshold used to determine whether repeated transmissions of the PRACH is satisfied, and a RAR corresponding to repeated transmissions of the PRACH (i.e., the RAR in the random access procedure), which is not limited in the present application.

In some embodiments, the first information includes a RAR in the random access procedure and/or whether the random access procedure is applicable to repeated transmissions of the PRACH.

In some embodiments, whether the random access procedure is applicable to repeated transmissions of the PRACH may also be expressed as:
whether the terminal device adopts repeated transmissions of the PRACH, or whether the terminal device performs repeated transmissions of the PRACH.

For example, that the random access procedure is applicable to repeated transmissions of the PRACH may be expressed as that the terminal device adopts repeated transmissions of the PRACH or that the terminal device performs repeated transmissions of the PRACH; and that the random access procedure is not applicable to repeated transmissions of the PRACH may be expressed as that the terminal device does not adopt repeated transmissions of the PRACH or that the terminal device does not perform repeated transmissions of the PRACH.

In some embodiments, whether the random access procedure is applicable to repeated transmissions of the PRACH may be determined according to an uplink coverage (or an uplink coverage level). For example, in a case where the uplink coverage is low to a certain extent, the terminal device may determine that the random access procedure is applicable to repeated transmissions of the PRACH.

Optionally, the uplink coverage may be determined by measuring a downlink signal.

That is, whether the random access procedure is applicable to repeated transmissions of the PRACH may be determined according to a measurement result of the downlink signal.

In some embodiments, the measurement result of the downlink signal includes but is not limited to at least one of:
reference signal receiving (or received) power (RSRP), reference signal receiving (or received) quality (RSRQ), signal to interference plus noise ratio (SINR), or received signal strength indication (or indicator) (RSSI).

In some embodiments, the terminal device may determine whether the random access procedure is applicable to repeated transmissions of the PRACH according to whether the measurement result of the downlink signal satisfies a second threshold.

For example, if the measurement result of the downlink signal satisfies the second threshold, it is determined that the random access procedure is applicable to repeated transmissions of the PRACH.

In another example, if the measurement result of the downlink signal does not satisfy the second threshold, it is determined that the random access procedure is not applicable to repeated transmissions of the PRACH.

Optionally, the measurement result of the downlink signal satisfying the second threshold may include that:
the measurement result of the downlink signal is less than the second threshold; or the measurement result of the downlink signal is less than or equal to the second threshold.

Optionally, the measurement result of the downlink signal not satisfying the second threshold may include that:
the measurement result of the downlink signal is greater than the second threshold; or
the measurement result of the downlink signal is greater than or equal to the second threshold.

Optionally, the second threshold may be configured by the network device, or may be predefined.

In some embodiments, the second threshold may be dedicated to determining whether the random access procedure is applicable to repeated transmissions of the PRACH. In other words, the second threshold is dedicated to determining whether a condition for repeated transmissions of the PRACH is satisfied.

That is, repeated transmissions of the PRACH correspond to an independent determination threshold.

In some embodiments, the second threshold may be used to determine whether the random access procedure is applicable to repeated transmissions of the PRACH, and may further be used to determine whether the random access procedure is applicable to repeated transmissions of the Msg3 PUSCH. In other words, the second threshold may be used to determine whether the condition for repeated transmissions of the PRACH is satisfied, and may further be used to determine whether a condition for repeated transmissions of the Msg3 PUSCH is satisfied.

That is, repeated transmissions of the PRACH and repeated transmissions of the Msg3 PUSCH may share the same determination threshold.

In some embodiments, the number of repeated transmissions of the PRACH may be determined according to a measurement result of a downlink signal.

For example, the terminal device may determine the number of repeated transmissions of the PRACH according to a measurement result of a downlink signal and a plurality of measurement result ranges, and the plurality of measurement result ranges respectively correspond to different quantities of repeated transmissions of the PRACH.

In some embodiments, the plurality of measurement result ranges are determined according to a plurality of thresholds.

In some embodiments, the plurality of measurement result ranges or the plurality of thresholds are configured by the network device, or may be predefined. For example, the network device may configure the plurality of measurement result ranges or the plurality of thresholds through a broadcast message, dedicated signaling (e.g., RRC signaling).

In some other embodiments, the number of repeated transmissions of the PRACH is configured by the network device or is predefined.

The method for determining repeated transmissions of the Msg3 PUSCH will be described with reference to embodiments below.

### Embodiment 1

In Embodiment 1, the first information includes whether the random access procedure is applicable to repeated transmissions of the PRACH, that is, whether the terminal device adopts repeated transmissions of the PRACH.

In some embodiments, S210 may include:
determining, by the terminal device according to the first information, the interpretation mode for the target MCS information field and/or whether to request repeated transmissions of the Msg3 PUSCH.

That is, the terminal device determines whether to request repeated transmissions of the Msg3 PUSCH according to whether repeated transmissions of the PRACH is adopted.

For example, in a case where the terminal device adopts repeated transmissions of the PRACH, the terminal device determines to request repeated transmissions of the Mg3 PUSCH.

In another example, in a case where the terminal device does not adopt repeated transmissions of the PRACH, the terminal device determines not to request repeated transmissions of the Mg3 PUSCH.

For the method for determining whether the terminal device adopts repeated transmissions of the PRACH, reference is made to the relevant description in the aforementioned embodiment, which will not be repeated here for brevity.

That is, in Embodiment 1, in a case where the terminal device adopts repeated transmissions of the PRACH, the terminal device simultaneously requests repeated transmissions of the Msg3 PUSCH. In other words, a determination condition for repeated transmissions of the PRACH may be understood as a determination condition for requesting repeated transmissions of the Msg3 PUSCH.

When the terminal device determines to adopt repeated transmissions of the PRACH, it means that the current uplink coverage is poor, and it is necessary to improve the uplink coverage of PRACH by repeated transmissions of the PRACH. Correspondingly, the uplink coverage of Msg3 PUSCH may also be poor. Therefore, when the terminal device determines to adopt repeated transmissions of the PRACH, the terminal device may simultaneously request repeated transmissions of the Msg3 PUSCH to improve the uplink coverage of Msg3 PUSCH.

In some embodiments, the terminal device may transmit the PRACH on a first PRACH resource to implicitly indicate a request for repeated transmissions of the Msg3 PUSCH to the network device. The first PRACH resource may be a resource used for repeated transmissions of the PRACH.

That is, the first PRACH resource may be used to indicate repeated transmissions of the PRACH, and further used to indicate a request for repeated transmissions of the Msg3 PUSCH. In other words, the first PRACH resource is associated with repeated transmissions of the PRACH and repeated transmissions of the Msg3 PUSCH.

Correspondingly, after receiving the PRACH transmitted by the terminal device on the first PRACH resource, the network device can determine that the terminal device adopts repeated transmissions of the PRACH and further requests repeated transmissions of the Msg3 PUSCH.

In some embodiments, determining, by the terminal device, the interpretation mode for the target MCS information field according to the first information includes:
in a case where the terminal device adopts repeated transmissions of the PRACH, determining, according to the target MCS information field, the number of repeated transmissions of the Msg3 PUSCH.

Optionally, in a case where the terminal device requests repeated transmissions of the Msg3 PUSCH, the network device may decide whether to schedule repeated transmissions of the Msg3 PUSCH and/or whether to indicate information on the number of repeated transmissions of the Msg3 PUSCH to the terminal device.

For example, in a case where the terminal device requests repeated transmissions of the Msg3 PUSCH, the network device indicates information on the number of repeated transmissions of the Msg3 PUSCH through the target MCS information field.

That is, in a case where the terminal device requests repeated transmissions of the Msg3 PUSCH, the network device may carry the information on the number of repeated transmissions of the Msg3 PUSCH in the target MCS information field.

In an example where FIG. 5 is taken for illustrating, the terminal device initiates random access and selects resources to be used for repeated transmissions of PRACH to perform repeated transmissions of a PRACH. When the network device receives a PRACH on the resource used for repeated transmissions of PRACH, the network device can determine that the terminal device adopts repeated transmissions of PRACH and further requests repeated transmissions of Msg3 PUSCH. Furthermore, the network device may indicate the number of repeated transmissions of Msg3 PUSCH in a RAR. For example, the number of repeated transmissions of Msg3 PUSCH is indicated by the 2 most significant bits in the MCS information field of the UL grant in RAR. Thus, the terminal device performs repeated transmissions of Msg3 PUSCH according to the number of repeated transmissions.

### Embodiment 2

In Embodiment 2, the first information includes a RAR in the random access procedure.

In some embodiments, S210 may include:
determining, by the terminal device, whether to perform repeated transmissions of the Msg3 PUSCH according to the RAR in the random access procedure, in a case where repeated transmissions of the PRACH is adopted.

In some embodiments, during the repeated transmission process of the PRACH, the terminal device may transmit a plurality of preambles, and transmit powers for transmitting the plurality of preambles may be gradually increased to increase the probability of successful detection of the network device. That is, a preamble may be used to indicate a transmit power.

In some embodiments, the network device may indicate a received preamble to the terminal device when transmitting the RAR, so that the terminal device may determine the power for transmitting the Msg3 PUSCH according to the preamble and improve the uplink coverage performance.

In some embodiments, the power for transmitting the preamble and the power for transmitting the Msg3 PUSCH are in an association relationship, for example, there is a specific power offset between them, and optionally, the specific power offset is configured through a high-layer parameter.

In some embodiments, the RAR includes first indication information. The first indication information may be used to determine the reception status of repeated transmissions of the PRACH, and the reception status of repeated transmissions of the PRACH may reflect the current uplink coverage level. For different uplink coverage levels, the requirements for repeated transmissions of the Msg3 PUSCH are different.

That is to say, in a case where the terminal device adopts repeated transmissions of the PRACH, the terminal device may determine the current uplink coverage level according to the RAR transmitted by the network device, and further determine whether to perform repeated transmissions of the Msg3 PUSCH according to the current uplink coverage level.

Alternatively, in a case where the terminal device adopts repeated transmissions of the PRACH, the network device may determine the current uplink coverage level according to repeated transmissions of the PRACH, then determine whether there is a need to perform repeated transmissions of the Msg3 PUSCH, and further indicate whether to perform repeated transmissions of Mg3 PUSCH to the terminal device via RAR.

In some embodiments, the first indication information is used to determine a target preamble, and the target preamble is a preamble in repeated transmissions of the PRACH. For example, in the repeated transmissions of the PRACH, the terminal device may transmit a plurality of preambles, and the target preamble may be a preamble detected by the network device, such as the first detected preamble, or all detected preambles.

It can be understood that the reception status of the preamble in repeated transmissions of the PRACH can reflect the current uplink coverage level.

It should be understood that the way of indicating the target preamble is not limited in the present application. For example, the network device may explicitly or implicitly indicate the target preamble in the RAR, such as by using a preamble index (PREAMBLE_INDEX), a number of the preamble, a resource location, or an order number corresponding to a transmission of the target preamble in the repeated transmissions of the PRACH.

That is to say, in the embodiments of the present application, in addition to being used to determine the transmit power of the Msg3 PUSCH, the target preamble is further used to determine whether to perform repeated transmissions of the Msg3 PUSCH.

In some embodiments, if the target preamble is received on a PRACH resource that is earlier in time in the repeated transmissions of the PRACH, the network device may determine that the uplink coverage is not poor, and thus, repeated transmissions of the Msg3 PUSCH may not be performed. Alternatively, if the target preamble is received on a PRACH resource that is later in time in the repeated transmissions of the PRACH, the network device may determine that the uplink coverage is poor, and thus, repeated transmissions of the Msg3 PUSCH may be performed.

Correspondingly, the terminal device determines the target preamble according to the first indication information in the received RAR. If the target preamble is transmitted on a PRACH resource that is earlier in time in the repeated transmissions of the PRACH, the terminal device determines not to perform repeated transmissions of the Msg3 PUSCH. Alternatively, if the target preamble is transmitted on a PRACH resource that is later in time in the repeated transmissions of the PRACH, the terminal device may determine to perform repeated transmissions of the Msg3 PUSCH.

It should be understood that, in the embodiments of the present application, the target preamble may be directly used to indicate a result of determining whether to perform the repeated transmissions of the Msg3 PUSCH, for example, there is a correspondence between the target preamble and whether to perform repeated transmissions of the Msg3 PUSCH. Alternatively, the terminal device may determine whether to perform repeated transmissions of the Msg3 PUSCH according to the target preamble, for example, the terminal device may determine whether to perform repeated transmissions of the Msg3 PUSCH according to the number of the target preamble and a first threshold. The determination method is not limited in the present application.

In some embodiments, the first indication information is used to indicate at least one of: index information of the target preamble (i.e., PREAMBLE_INDEX);
a random access radio network temporary identifier (RA-RNTI) of a physical downlink control channel (PDCCH), where the RA-RNTI is determined according to a resource location on which the target preamble is located, and the PDCCH is used to schedule the RAR;
a PRACH occasion in which the target preamble is located;
number information of the target preamble in a plurality of preambles, where the plurality of preambles are preamble transmitted in repeated transmissions of the PRACH; or
a transmission order number corresponding to a transmission of the target preamble in repeated transmissions of the PRACH.

In some embodiments, the RAR transmitted by the network device may be scheduled by a PDCCH, the PDCCH may be scrambled by a RA-RNTI, and the RA-RNTI may be determined according to a time-frequency resource location on which the preamble is located. That is, different PRACH resources may correspond to different RA-RNTIs. Therefore, the terminal device that selects a specific PRACH resource to transmit PRACH may receive the RAR according to the RA-RNTI corresponding to the specific PRACH resource and determine the target preamble according to the RA-RNTI.

In some embodiments, the network device may number PRACH occasions in which a plurality of preambles are located respectively, and further indicate a number of a PRACH occasion in the RAR, so that the terminal device may determine which preamble corresponds to the PRACH occasion number.

In some embodiments, the network device may notify the terminal device, via the RAR, of which transmission in the repeated transmissions of the PRACH is the transmission in which the network device received the target preamble. For example, the network device may number the repeated transmissions of the PRACH based on transmission time, and further indicate the number of the transmission corresponding to the received preamble in the RAR.

In some embodiments, the network device may number a plurality of preambles transmitted by the terminal device in repeated transmissions of the PRACH, such as number the preambles in the order of transmission time. For example, the plurality of preambles include four preambles, and the numbers of the four preambles may be 0 to 3, respectively. Further, the number of a preamble is carried in the RAR.

In some embodiments, the terminal device may determine whether to perform repeated transmissions of the Msg3 PUSCH according to the preamble indicated by the first indication information in the RAR.

For example, whether to perform repeated transmissions of the Msg3 PUSCH is determined according to the number of a transmission of the target preamble in repeated transmissions of the PRACH.

It should be understood that the number of the transmission of the target preamble in the repeated transmissions of the PRACH may be determined according to the index information of the target preamble. For example, which transmission corresponds to the transmission of the target preamble may be determined according to the index information of the target preamble, or according to an RA-RNTI for scrambling a PDCCH scheduling the RAR, or according to a PRACH occasion in which the preamble is located, or according to the number of the target preamble in the plurality of preambles, or according to the transmission number corresponding to the transmission of the target preamble, which is not limited in the present application.

In some embodiments, there may be a correspondence between the number of the transmission of the target preamble in the repeated transmissions of the PRACH and whether to perform repeated transmissions of the Msg3 PUSCH. For example, number 0 or 1 corresponds to not performing repeated transmissions of the Msg3 PUSCH, while number 2 or 3 corresponds to performing repeated transmissions of the Msg3 PUSCH.

For example, preambles transmitted in four repeated transmissions of the PRACH are numbered 0 to 3 according to the order of transmission time. If the network device detects a preamble on a PRACH resource that is earlier in time in the repeated transmissions of the PRACH, and indicates the number of the preamble in the RAR, for example, by indicating that the number of the preamble is 0 or 1, the terminal device considers not performing repeated transmissions of the Msg3 PUSCH. If the network device detects a preamble on a PRACH resource that is later in time in the repeated transmissions of the PRACH, and indicates the number of the preamble in the RAR, for example, by indicating that the number of the preamble is 2 or 3, the terminal device considers performing repeated transmissions of the Msg3 PUSCH.

Optionally, the correspondence may be configured by the network device or may be predefined.

In some other embodiments, the terminal device may determine whether to perform repeated transmissions of the Msg3 PUSCH according to the number of the transmission of the target preamble in the repeated transmissions of the PRACH and the first threshold.

For example, if the number of the transmission of the target preamble in repeated transmissions of the PRACH satisfies the first threshold, it is determined to perform repeated transmissions of the Msg3 PUSCH.

In another example, if the number of the transmission of the target preamble in the repeated transmissions of the PRACH does not satisfy the first threshold, it is determined not to perform repeated transmissions of the Msg3 PUSCH.

In some embodiments, the first threshold is predefined, or is configured by the network device.

In some embodiments, the number of the transmission of the target preamble in the repeated transmissions of the PRACH satisfying the first threshold may include:
the number of the transmission of the target preamble in repeated transmissions of the PRACH is greater than the first threshold; or
the number of the transmission of the target preamble in repeated transmissions of the PRACH is greater than or equal to the first threshold.

That is, in a case where the preamble is received at a location that is later in time, the uplink coverage may be considered poor, so the terminal device performs repeated transmissions of the Msg3 PUSCH.

In some embodiments, the number of the transmission of the target preamble in the repeated transmissions of the PRACH not satisfying the first threshold may include:
the number of the transmission of the target preamble in the repeated transmissions of the PRACH is less than the first threshold; or
the number of the transmission of the target preamble in the repeated transmissions of the PRACH is less than or equal to the first threshold.

That is, in a case where the preamble is received at a location that is earlier in time, the uplink coverage may be considered not poor, and the terminal device does not need to perform repeated transmissions of the Msg3 PUSCH.

Optionally, in a case where the network device indicates to perform repeated transmissions of the Msg3 PUSCH, the network device may further indicate information on the number of repeated transmissions of the Msg3 PUSCH.

For example, the network device may indicate information on the number of repeated transmissions of the Msg3 PUSCH through the target MCS information field. For the way of indicating, please refer to the relevant description in the embodiments in above, which will not be repeated here.

Correspondingly, in a case of performing repeated transmissions of the Msg3 PUSCH, the terminal device may determine the information on the number of repeated transmissions of the Msg3 PUSCH according to the target MCS information field.

In some other embodiments, in the case of performing repeated transmissions of the Msg3 PUSCH, the network device may indicate the information on the number of repeated transmissions of the Msg3 PUSCH through the target preamble.

For example, different target preambles correspond to different information on the number of repeated transmissions.

In some embodiments, there is a correspondence between the number of a preamble (which may also be replaced by other content indicated by the first indication information) and the information on the number of repeated transmissions of the Msg3 PUSCH.

In some embodiments, there is a correspondence between the number of a preamble and the information on a default number of repeated transmissions of the Msg3 PUSCH

For example, the numbers of a preamble, 0 to 3, correspond to the quantities of repeated transmissions of the Msg3 PUSCH, 1 to 4, respectively.

In some other embodiments, there is a correspondence between the number of a preamble and the information on the number of repeated transmissions of the Msg3 PUSCH configured by the network device.

For example, the numbers of a preamble, 0 to 3, correspond to the quantities of repeated transmissions of the Msg3 PUSCH configured by the network device, 1, 2, 4, and 8, respectively.

In some embodiments of the present application, the network device may distinguish random access of terminal devices with different features through PRACH resources.

For example, the network device may configure the PRACH resources according to a FeatureCombination.

Optionally, repeated transmissions of the Msg3 PUSCH is one feature in the FeatureCombination.

Optionally, the FeatureCombination may include at least one of:
repeated transmissions of the PRACH (denoted as FeatureCombination 1), repeated transmissions of the PRACH and repeated transmissions of the Msg3 PUSCH (denoted as FeatureCombination 2), or repeated transmissions of the Msg3 PUSCH (denoted as FeatureCombination 3).

In some embodiments, the network device may configure associated PRACH resources for repeated transmissions of the Msg3 PUSCH.

In some embodiments, the network device may configure associated PRACH resources for repeated transmissions of the PRACH.

In some embodiments, the network device may configure associated PRACH resources for repeated transmissions of the PRACH and repeated transmissions of the Msg3 PUSCH.

For a terminal device that supports repeated transmissions of the Msg3 PUSCH, in a case where repeated transmissions of the Msg3 PUSCH is requested, PRACH resources associated with the feature of repeated transmissions of the Msg3 PUSCH may be selected to transmit PRACH; and in a case where repeated transmissions of the Msg3 PUSCH is not requested, PRACH resources not associated with the feature of repeated transmissions of the Msg3 PUSCH may be selected to transmit PRACH.

In some embodiments, in a case where repeated transmissions of the PRACH is associated with repeated transmissions of the Msg3 PUSCH, PRACH resources associated with repeated transmissions of the PRACH and PRACH resources associated with repeated transmissions of the Msg3 PUSCH may be sharable, such as a shared preamble set and/or a shared PRACH occasion set.

For example, the network device may configure a preamble set and/or a shared PRACH occasion through a FeatureCombinationPreambles information element. The preamble set or shared PRACH occasion is associated with FeatureCombination 3.

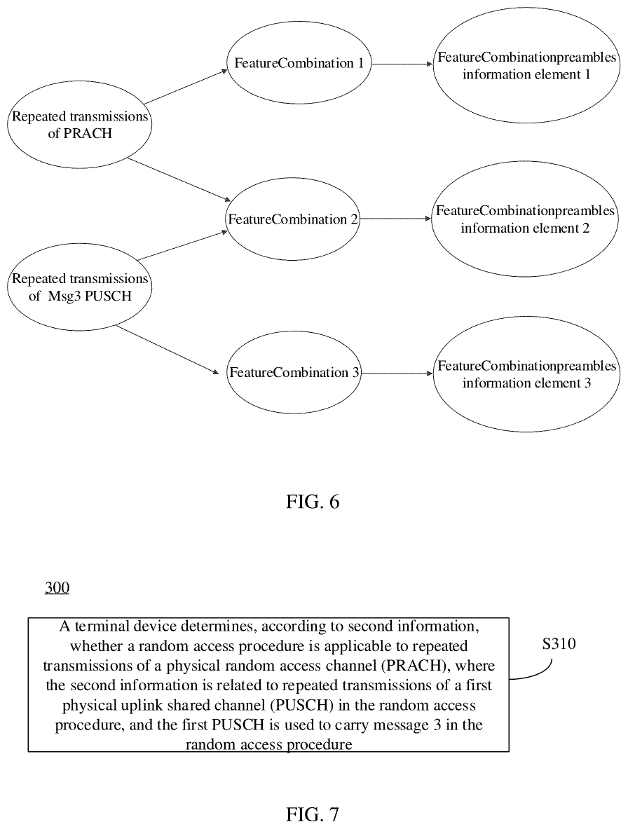

In some embodiments, as shown in FIG. 6, the network configures three FeatureCombinationpreambles information elements, in which the FeatureCombination associated with FeatureCombinationpreambles information element 1 includes repeated transmissions of the PRACH but does not include repeated transmissions of the Msg3 PUSCH, the FeatureCombination associated with FeatureCombinationpreambles information element 2 includes repeated transmissions of the PRACH and repeated transmissions of the Msg3 PUSCH, and the FeatureCombination associated with FeatureCombinationpreambles information element 3 includes repeated transmissions of the Msg3 PUSCH but does not include repeated transmissions of the PRACH. Each FeatureCombinationpreambles information element is used to configure PRACH resources associated with the corresponding FeatureCombination.

Optionally, if the terminal device determines to adopt repeated transmissions of the PRACH and requests repeated transmissions of the Msg3 PUSCH, a PRACH is transmitted via a first PRACH resource. Here, the first PRACH resource belongs to a first PRACH resource set, and the first PRACH resource set is associated with repeated transmissions of the PRACH and repeated transmissions of the Msg3 PUSCH. The first PRACH resource set may be a PRACH resource set allocated by FeatureCombinationpreambles information element 1.

Optionally, if the terminal device adopts repeated transmissions of the PRACH and does not request repeated transmissions of the Msg3 PUSCH, a PRACH is transmitted via a second PRACH resource, the second PRACH resource belongs to a second PRACH resource set, and the second PRACH resource set is associated with repeated transmissions of the PRACH. The second PRACH resource set may be a PRACH resource set allocated by FeatureCombinationpreambles information element 2.

Optionally, the terminal device does not adopt repeated transmissions of the PRACH and requests repeated transmissions of the Msg3 PUSCH, a PRACH is transmitted via a third PRACH resource, the third PRACH resource belongs to a third PRACH resource set, and the third PRACH resource set is associated with repeated transmissions of the first PUSCH. The third PRACH resource set may be a PRACH resource set allocated by FeatureCombinationpreambles information element 3.

In summary, in the embodiments of the present application, the terminal device may associate repeated transmissions of the Msg3 PUSCH with repeated transmissions of the PRACH, which is beneficial to improving the uplink coverage performance of Msg3 PUSCH and to reducing the implementation complexity of the terminal device.

FIG. 7 is a schematic flowchart of another wireless communication method 300 according to the embodiments of the present application. As shown in FIG. 7, the method 300 includes at least part of the following contents.

In S310, a terminal device determines, according to second information, whether a random access procedure is applicable to repeated transmissions of a physical random access channel (PRACH), where the second information is related to repeated transmissions of a first physical uplink shared channel (PUSCH) in the random access procedure, and the first PUSCH is used to carry message 3 in the random access procedure.

In some embodiments, the terminal device supports both repeated transmissions of the PRACH and repeated transmissions of the Msg3 PUSCH.

In the embodiments of the present application, a PUSCH used to carry Msg3 may also be referred to as a Msg3 PUSCH. That is, the first PUSCH is the Msg3 PUSCH.

In some embodiments, whether the random access procedure is applicable to repeated transmissions of the PRACH may also be expressed as:
whether the terminal device adopts repeated transmissions of the PRACH, or whether the terminal device performs repeated transmissions of the PRACH.

It should be understood that the same terms in method 300 and method 200 may be interpreted in the same way, which will not be repeated here for brevity.

The determination of whether the random access procedure is applicable to repeated transmissions of the PRACH will be described in detail in the following.

### Method 1:

In some embodiments, whether the random access procedure is applicable to repeated transmissions of the PRACH may be determined according to an uplink coverage (or an uplink coverage level). For example, in a case where the uplink coverage is low to a certain extent, the terminal device may determine that the random access procedure is applicable to repeated transmissions of the PRACH.

Optionally, the uplink coverage may be determined by measuring a downlink signal.

That is, whether the random access procedure is applicable to repeated transmissions of the PRACH may be determined according to a measurement result of the downlink signal.

In some embodiments, the measurement result of the downlink signal includes at least one of: RSRP, RSRQ, SINR, or RSSI.

In some embodiments, the terminal device may determine whether the random access procedure is applicable to repeated transmissions of the PRACH according to whether the measurement result of the downlink signal satisfies a second threshold.

For example, if the measurement result of the downlink signal satisfies the second threshold, it is determined that the random access procedure is applicable to repeated transmissions of the PRACH.

In another example, if the measurement result of the downlink signal does not satisfy the second threshold, it is determined that the random access procedure is not applicable to repeated transmissions of the PRACH.

Optionally, the measurement result of the downlink signal satisfying the second threshold may include:
the measurement result of the downlink signal is less than the second threshold; or
the measurement result of the downlink signal is less than or equal to the second threshold.

Optionally, the measurement result of the downlink signal not satisfying the second threshold may include:
the measurement result of the downlink signal is greater than the second threshold; or
the measurement result of the downlink signal is greater than or equal to the second threshold.

It should be understood that, in Method 1, whether the random access procedure is applicable to repeated transmissions of the PRACH may not be associated with repeated transmissions of the Msg3 PUSCH. For example, whether the random access procedure is applicable to repeated transmissions of the PRACH and whether the random access procedure is applicable to repeated transmissions of the Msg3 PUSCH may be determined based on independent determination conditions, such as different RSRP thresholds.

### Method 2:

Whether the random access procedure is applicable to repeated transmissions of the PRACH is determined according to the second information.

It should be understood that in the embodiments of the present application, the second information may refer to any information related to repeated transmissions of the Msg3 PUSCH, such as, whether the random access procedure is applicable to repeated transmissions of the Msg3 PUSCH, whether the terminal device adopts repeated transmissions of the Msg3 PUSCH, whether a condition for the repeated transmissions of the Msg3 PUSCH are met, a determination threshold used to determine whether a condition for repeated transmissions of the Msg3 PUSCH is satisfied, which is not limited in the present application.

In the following, the second information including whether the condition for requesting repeated transmissions of the Msg3 PUSCH is satisfied is taken as an example for illustrating, which is not limited in the present application. In other words, whether to request repeated transmissions of the Msg3 PUSCH and whether to adopt repeated transmissions of the PRACH may share the same determination condition, for example, share the same threshold.

In some embodiments, whether the random access procedure is applicable to repeated transmissions of the Msg3 PUSCH may refer to:
whether repeated transmissions of the Msg3 PUSCH is required in the random access procedure, or whether there is a need for repeated transmissions of the Msg3 PUSCH.

In some embodiments, whether the random access procedure is applicable to repeated transmissions of the Msg3 PUSCH may include at least one of:
whether the terminal device requests repeated transmissions of the Msg3 PUSCH in the random access procedure, or whether the terminal device performs repeated transmissions of the Msg3 PUSCH.

In some embodiments of the present application, S310 includes:
determining that the random access procedure is applicable to repeated transmissions of the PRACH, in a case where the condition for requesting repeated transmissions of the first PUSCH is satisfied; or
determining that repeated transmissions of the PRACH is not applicable to the random access procedure, in a case where the condition for requesting repeated transmissions of the first PUSCH is not satisfied.

In some embodiments, whether the condition for requesting repeated transmissions of the Msg3 PUSCH is satisfied may be determined according to the uplink coverage level. Optionally, the uplink coverage may be determined by measuring the downlink signal.

In some embodiments, the method 300 further includes:
determining whether the condition for requesting repeated transmissions of the Msg3 PUSCH is satisfied according to a measurement result of a downlink signal.

For example, in a case where the measurement result of the downlink signal satisfies a third threshold, it is determined that the condition for requesting repeated transmissions of the Msg3 PUSCH is satisfied.

In another example, in a case where the measurement result of the downlink signal does not satisfy the third threshold, it is determined that the condition for requesting repeated transmissions of the Msg3 PUSCH is not satisfied.

Optionally, the measurement result of the downlink signal satisfying the third threshold may include that:
the measurement result of the downlink signal is less than the third threshold; or
the measurement result of the downlink signal is less than or equal to the third threshold.

Optionally, the measurement result of the downlink signal not satisfying the third threshold may include that:
the measurement result of the downlink signal is greater than the third threshold; or
the measurement result of the downlink signal is greater than or equal to the third threshold.

In summary, the third threshold may be used to determine whether the random access procedure is applicable to repeated transmissions of the Msg3 PUSCH, and may further be used to determine whether the random access procedure is applicable to repeated transmissions of the PRACH. In other words, the third threshold may be used to determine whether a condition for repeated transmission of Msg3 PUSCH is satisfied, and may further be used to determine whether a condition for repeated transmission condition of PRACH is satisfied.

In some embodiments, the number of repeated transmissions of the PRACH is configured by a network device or is predefined.

In some embodiments, the number of repeated transmissions of the PRACH may be determined according to a measurement result of a downlink signal.

For example, the terminal device may determine the number of repeated transmissions of the PRACH according to the measurement result of the downlink signal and a plurality of measurement result ranges, and the plurality of measurement result ranges respectively correspond to different quantities of repeated transmissions of the PRACH.

In some embodiments, the plurality of measurement result ranges are determined according to a plurality of thresholds.

In some embodiments, the plurality of measurement result ranges or the plurality of thresholds are configured by the network device, or may be predefined. For example, the network device may configure the plurality of measurement result ranges or the plurality of thresholds through a broadcast message, dedicated signaling (e.g., RRC signaling).

In some embodiments of the present application, the network device may distinguish random access of terminal devices with different features through PRACH resources.

For example, the network device may configure the PRACH resources according to a FeatureCombination.

Optionally, the repeated transmissions of the Msg3 PUSCH is one feature in the FeatureCombination.

Optionally, the FeatureCombination may include at least one of:
only repeated transmissions of the PRACH (denoted as FeatureCombination 1), repeated transmissions of the PRACH and repeated transmissions of the Msg3 PUSCH (denoted as FeatureCombination 2), or only repeated transmissions of the Msg3 PUSCH (denoted as FeatureCombination 3).

In some embodiments, the network device may configure associated PRACH resources for repeated transmissions of the Msg3 PUSCH.

In some embodiments, the network device may configure associated PRACH resources for repeated transmissions of the PRACH.

In some embodiments, the network device may configure associated PRACH resources for repeated transmissions of the PRACH and repeated transmissions of the Msg3 PUSCH.

In some embodiments, in a case where repeated transmissions of the PRACH is associated with repeated transmissions of the Msg3 PUSCH, PRACH resources associated with repeated transmissions of the PRACH and PRACH resources associated with repeated transmissions of the Msg3 PUSCH may be sharable, such as a shared preamble set and/or a shared PRACH occasion set.

For example, the network device may configure a preamble set and/or a shared PRACH occasion through a FeatureCombinationPreambles information element. The preamble set or shared PRACH occasion is associated with FeatureCombination 3.

For a way of configuring FeatureCombinationpreambles information element, please refer to the relevant description in the embodiment shown in FIG. 6 above, which will not be repeated here for brevity.

Optionally, in some embodiments, if whether the random access procedure is applicable to repeated transmissions of the PRACH and whether the random access procedure is applicable to repeated transmissions of the Msg3 PUSCH are determined according to independent determination conditions respectively, in this case, the network device may configure PRACH resources associated with repeated transmissions of the PRACH and PRACH resources associated with repeated transmissions of the Msg3 PUSCH. A portion of the PRACH resources associated with repeated transmissions of PRACH may be associated with repeated transmissions of the Msg3 PUSCH, and another portion of the PRACH resources are not associated with repeated transmissions of the Msg3 PUSCH. A portion of the PRACH resources associated with repeated transmissions of the Msg3 PUSCH may be associated with repeated transmissions of PRACH, and another portion of the PRACH resources are not associated with repeated transmissions of the PRACH.

Thus, in a case where the terminal device determines to adopt repeated transmissions of the PRACH and determines to request repeated transmissions of the Msg3 PUSCH, the PRACH may be transmitted by using PRACH resources associated with repeated transmissions of the Msg3 PUSCH among the PRACH resources associated with repeated transmissions of the PRACH. Alternatively, if the terminal device determines to request repeated transmissions of the Msg3 PUSCH but does not adopt repeated transmissions of the PRACH, the PRACH may be transmitted by using PRACH resources that are not associated with repeated transmissions of the PRACH among the PRACH resources associated with repeated transmissions of the Msg3 PUSCH.

In summary, in the embodiments of the present application, the terminal device may associate the repeated transmissions of the PRACH with the repeated transmissions of the Msg3 PUSCH, which is beneficial to reducing the implementation complexity of the terminal device and improving the uplink coverage performance of PRACH.

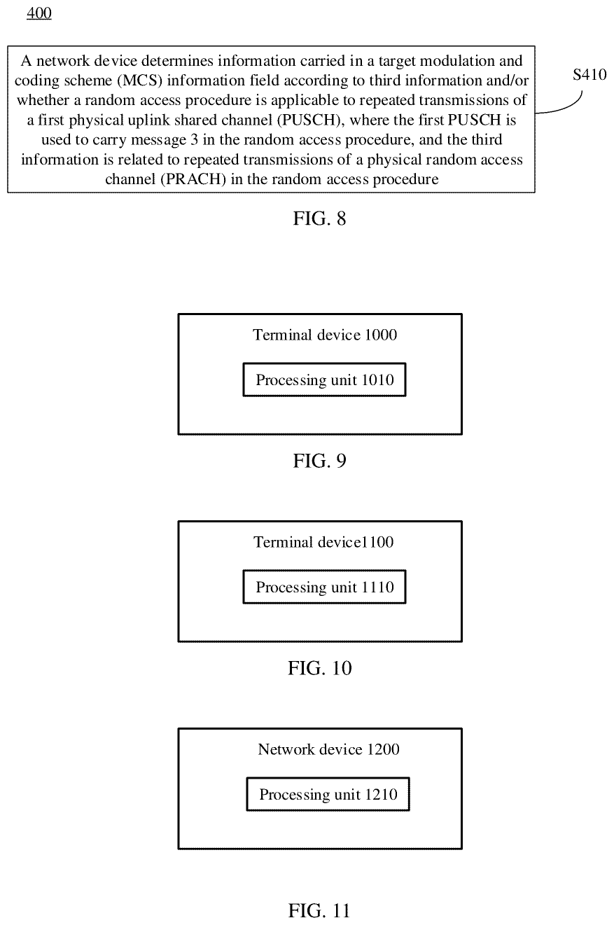

FIG. 8 is a schematic flowchart of another wireless communication method 400 according to the embodiments of the present application. As shown in FIG. 8, the method 400 includes at least part of the following contents.

In S410, a network device determines information carried in a target modulation and coding scheme (MCS) information field according to third information and/or whether a random access procedure is applicable to repeated transmissions of a first physical uplink shared channel (PUSCH), where the first PUSCH is used to carry message 3 (i.e., Msg3 PUSCH) in the random access procedure, and the third information is related to repeated transmissions of a physical random access channel (PRACH) in the random access procedure.

It should be understood that, regarding terms involved in the method 400, reference may be made to the explanation of corresponding terms in the method 200, which will not be repeated here for brevity.

It should be understood that, regarding implementations in the network device side in the method 400, reference may be made to the relevant implementations about the network device in the method 200, which will not be repeated here for brevity.

In some embodiments, the network device determining whether the random access procedure is applicable to repeated transmissions of the first physical uplink shared channel PUSCH may include:
the network device determining whether the terminal device requests repeated transmissions of the Msg3 PUSCH in the random access procedure, or
the network device determining whether there is a need for repeated transmissions of the Msg3 PUSCH in the random access procedure (or in other words, whether repeated transmissions of the Msg3 PUSCH are performed in the random access procedure).

It should be understood that in the embodiments of the present application, the third information may refer to any information related to repeated transmissions of the PRACH, such as whether the random access procedure is applicable to repeated transmissions of the PRACH, or whether the terminal device adopts repeated transmissions of the PRACH, which is not limited in the present application.

In some embodiments, the third information includes a target preamble transmitted in repeated transmissions of the PRACH and/or whether the terminal device adopts repeated transmissions of the PRACH.

Optionally, regarding the way to indicate the target preamble, reference may be made to the relevant description in method 200, which will not be repeated here for brevity.

In some embodiments of the present application, the method 400 may include:
determining, according to whether the terminal device adopts repeated transmissions of the PRACH, the information carried in the target MCS information field and/or whether the terminal device requests repeated transmissions of the Msg3 PUSCH.

For example, in a case where the terminal device adopts repeated transmissions of the PRACH, it is determined that the terminal device requests repeated transmissions of the Msg3 PUSCH.

In another example, in a case where the terminal device does not adopt repeated transmissions of the PRACH, it is determined that the terminal device does not request repeated transmissions of the Msg3 PUSCH.

In some embodiments of the present application, S410 may include:
determining information on the number of repeated transmissions of the first PUSCH carried in the target MCS information field, in a case where the terminal device adopts repeated transmissions of the PRACH.

In some embodiments of the present application, S410 may include:
determining, according to the target preamble transmitted in repeated transmissions of the PRACH, the information carried in the target MCS information field and/or whether the random access procedure is applicable to repeated transmissions of the Msg3 PUSCH, in a case where the terminal device adopts repeated transmissions of the PRACH.

For example, the information carried in the target MCS information field and/or whether the random access procedure is applicable to repeated transmissions of the Msg3 PUSCH are determined according to the number of a transmission of the target preamble in repeated transmissions of the PRACH.

As an example, if the number of the transmission of the target preamble in the repeated transmissions of the PRACH satisfies the first threshold, it is determined that the random access procedure is applicable to the repeated transmissions of the Msg3 PUSCH.

As an example, if the number of the transmission of the target preamble in the repeated transmissions of the PRACH does not satisfy the first threshold, it is determined that the random access procedure is not applicable to the repeated transmissions of the Msg3 PUSCH.

For example, preambles transmitted in four repeated transmissions of the PRACH are numbered 0 to 3 according to the order of transmission time. If the network device detects a preamble on a PRACH resource that is earlier in time in the repeated transmissions of the PRACH, and indicates the number of the preamble in the RAR, for example, indicating that the number of the preamble is 0 or 1, it indicates to perform repeated transmissions of the Msg3 PUSCH. If the network device detects a preamble on a PRACH resource that is later in time in the repeated transmissions of the PRACH, and indicates the number preamble in the RAR, for example, indicating that the number of the preamble is 2 or 3, it indicates to perform repeated transmissions of the Msg3 PUSCH.

In some embodiments of the present application, the method 400 further includes:
transmitting, by the network device, a random access response (RAR) to the terminal device, where the RAR includes first indication information, the first indication information is used to determine the target preamble, and the first indication information is used by the terminal device to determine whether to perform repeated transmissions of the first PUSCH.

In some embodiments of the present application, the first indication information is used to indicate at least one of:
index information of the target preamble;
number information of the target preamble in a plurality of preambles, where the plurality of preambles are preambles transmitted in repeated transmissions of the PRACH;
a random access radio network temporary identifier (RA-RNTI) of a physical downlink control channel (PDCCH), where the RA-RNTI is determined according to a resource location on which the target preamble is located, and the PDCCH is used to schedule the RAR;
a PRACH occasion in which the target preamble is located; or
a transmission order number corresponding to a transmission of the target preamble in repeated transmissions of the PRACH.

In some embodiments of the present application, determining the information carried in the target MCS information field according to the number of the transmission of the target preamble in repeated transmissions of the PRACH includes:
if the number of the transmission of the target preamble in repeated transmissions of the PRACH satisfies the first threshold (i.e., it is determined to perform repeated transmissions of the Msg3 PUSCH), determining information on the number of repeated transmissions of the Msg3 PUSCH that is carried in the target MCS information field.

In some embodiments, the number of the transmission of the target preamble in repeated transmissions of the PRACH is further used to determine the number of repeated transmissions of the first PUSCH.

In some embodiments, the method 400 further includes:
determining, according to a PRACH resource used by the terminal device for transmitting the PRACH, whether the terminal device adopts repeated transmissions of the PRACH.

For example, if the network device receives a PRACH on a first PRACH resource, and the first PRACH resource is associated with repeated transmissions of the PRACH and repeated transmissions of the Msg3 PUSCH, the network device may determine that the terminal device determines to adopt repeated transmissions of the PRACH and also requests repeated transmissions of the Msg3 PUSCH.

In another example, if the network device receives a PRACH on a second PRACH resource, and the second PRACH resource is associated with repeated transmissions of the PRACH, the network device may determine that the terminal device determines to adopt repeated transmissions of the PRACH and does not request repeated transmissions of the Msg3 PUSCH.

In another example, if the network device receives a PRACH on a third PRACH resource, and the third PRACH resource is associated with repeated transmissions of the Msg3 PUSCH, the network device may determine that the terminal device determines to adopt repeated transmissions of Msg3 PRACH and does not adopt repeated transmissions of the PRACH.

In some embodiments, the method 400 further includes:
transmitting, by the network device, first configuration information to the terminal device, where the first configuration information is used to configure a target PRACH resource set, and the target PRACH resource set is associated with repeated transmissions of the PRACH and/or repeated transmissions of the first PUSCH.

For example, the target PRACH resource set includes at least one of:
a first PRACH resource set, associated with repeated transmissions of the PRACH and repeated transmissions of the first PUSCH;
a second PRACH resource set, associated with repeated transmissions of the PRACH; or a third PRACH resource set, associated with repeated transmissions of the first PUSCH.

The method embodiments of the present application have been described in detail above with reference to FIGS. 4 to 8. The device embodiments of the present application will be described in detail below with reference to FIGS. 9 to 14. It should be understood that the device embodiments and the method embodiments correspond to each other, and similar descriptions can refer to the method embodiment.

FIG. 9 illustrates a schematic block diagram of a terminal device 1000 according to the embodiments of the present application. As shown in FIG. 9, the terminal device 1000 includes: a processing unit 1010, configured to determine, according to first information, an interpretation mode of a target modulation and coding scheme (MCS) information field and/or whether a random access procedure is applicable to repeated transmissions of a first physical uplink shared channel (PUSCH), where the first PUSCH is used to carry message 3 in the random access procedure, and the first information is related to repeated transmissions of a physical random access channel (PRACH) in the random access procedure.

In some embodiments, the first information includes a random access response (RAR) in the random access procedure and/or whether the random access procedure is applicable to repeated transmissions of the PRACH.

In some embodiments, the processing unit 1010 is further configured to:
determine, according to the first information, the interpretation mode of the target modulation and coding scheme (MCS) information field and/or whether to request repeated transmissions of a first physical uplink shared channel (PUSCH).

In some embodiments, the processing unit 1010 is further configured to:
determine to request repeated transmissions of the first PUSCH, in a case where the random access procedure is applicable to repeated transmissions of the PRACH; or determine not to request repeated transmissions of the first PUSCH, in a case where the random access procedure is not applicable to repeated transmissions of the PRACH.

In some embodiments, the processing unit 1010 is further configured to:
determine the number of repeated transmissions of the first PUSCH according to the target MCS information field, in a case where the random access procedure is applicable to repeated transmissions of the PRACH.

In some embodiments, the processing unit 1010 is further configured to:
determine, according to the RAR, the interpretation mode for the target MCS information field and/or whether to perform repeated transmissions of the first PUSCH, in a case where the random access procedure is applicable to repeated transmissions of the PRACH.

In some embodiments, the RAR includes first indication information, the first indication information is used to determine a target preamble, and the target preamble is a preamble transmitted in repeated transmissions of the PRACH.

In some embodiments, the first indication information is used to indicate at least one of:
index information of the target preamble;
index information of the target preamble;
a random access radio network temporary identifier (RA-RNTI) of a physical downlink control channel (PDCCH), where the RA-RNTI is determined according to a resource location on which the target preamble is located, and the PDCCH is used to schedule the RAR;
a PRACH occasion in which the target preamble is located;
number information of the target preamble in a plurality of preambles, where the plurality of preambles are preambles transmitted in repeated transmissions of the PRACH; or
a transmission order number corresponding to a transmission of the target preamble in repeated transmissions of the PRACH.

In some embodiments, the processing unit 1010 is further configured to:
determine, according to the number of the transmission of the target preamble in repeated transmissions of the PRACH, the interpretation mode for the target MCS information field and/or whether to perform repeated transmissions of the first PUSCH.

In some embodiments, the processing unit 1010 is further configured to:
determine to perform repeated transmissions of the first PUSCH, if the number of the transmission of the target preamble in repeated transmissions of the PRACH satisfies a first threshold; or
determine not to perform repeated transmissions of the first PUSCH, if the number of the transmission of the target preamble in repeated transmissions of the PRACH does not satisfy the first threshold.

In some embodiments, the processing unit 1010 is further configured to:
determine the number of repeated transmissions of the first PUSCH according to the target MCS information field, if the number of the transmission of the target preamble in repeated transmissions of the PRACH satisfies the first threshold.

In some embodiments, the number of repeated transmissions of the first PUSCH is determined according to the number of the transmission of the target preamble in repeated transmissions of the PRACH.

In some embodiments, the processing unit 1010 is further configured to:
determine whether the random access procedure is applicable to repeated transmissions of the PRACH according to a measurement result of a downlink signal.

In some embodiments, the processing unit 1010 is further configured to:
determine that the random access procedure is applicable to repeated transmissions of the PRACH, in a case where the measurement result of the downlink signal satisfies a second threshold; or
determine that the random access procedure is not applicable to repeated transmissions of the PRACH, in a case where the measurement result of the downlink signal does not satisfy the second threshold.

In some embodiments, the processing unit 1010 is further configured to:
determine the number of repeated transmissions of the PRACH according to the measurement result of the downlink signal and a plurality of measurement result ranges, where the plurality of measurement result ranges respectively correspond to different quantities of repeated transmissions of the PRACH, and the plurality of measurement result ranges are determined according to a plurality of thresholds.

In some embodiments, in a case where the terminal device adopts repeated transmissions of the PRACH and requests repeated transmissions of the first PUSCH, the PRACH is transmitted via a first PRACH resource, the first PRACH resource belongs to a first PRACH resource set, and the first PRACH resource set is associated with repeated transmissions of the PRACH and repeated transmissions of the first PUSCH.

In some embodiments, in a case where the terminal device adopts repeated transmissions of the PRACH and does not request repeated transmissions of the first PUSCH, the PRACH is transmitted via a second PRACH resource, the second PRACH resource belongs to a second PRACH resource set, and the second PRACH resource set is associated with repeated transmissions of the PRACH.

In some embodiments, in a case where the terminal device does not adopt repeated transmissions of the PRACH and requests repeated transmissions of the first PUSCH, the PRACH is transmitted via a third PRACH resource, the third PRACH resource belongs to a third PRACH resource set, and the third PRACH resource set is associated with repeated transmissions of the first PUSCH.

In some embodiments, the target MCS information field is an MCS information field in an uplink grant of a RAR corresponding to the PRACH; or
the target MCS information field is an MCS information field carried by a downlink control information (DCI) format 0_0 scrambled by a temporary cell radio network temporary identifier (TC-RNTI).

Optionally, in some embodiments, the communication unit mentioned above may be a communication interface or a transceiver, or an input/output interface of a communication chip or a system on chip. The processing unit mentioned above may be one or more processors.

It should be understood that the terminal device 1000 according to the embodiments of the present application may correspond to the terminal device in the method embodiments of the present application, and the above-mentioned and other operations and/or functions of each unit in the terminal device 1000 are respectively for implementing the corresponding processes of the terminal device in the method 200 shown in FIG. 4 to FIG. 6, which will not be repeated here for brevity.

FIG. 10 illustrates a schematic block diagram of a terminal device 1100 according to the embodiments of the present application. As shown in FIG. 10, the terminal device 1100 includes: a processing unit 1110, configured to determine whether a random access procedure is applicable to repeated transmissions of a physical random access channel (PRACH) according to second information, where the second information is related to repeated transmissions of a first physical uplink shared channel (PUSCH) in the random access procedure, and the first PUSCH is used to carry message 3 in the random access procedure.

In some embodiments, the second information includes whether a condition for requesting repeated transmissions of the first PUSCH is satisfied.

In some embodiments, the processing unit 1110 is further configured to:
determine that the random access procedure is applicable to repeated transmissions of the PRACH, in a case where the condition for requesting repeated transmissions of the first PUSCH is satisfied; or
determine that the random access procedure is not applicable to repeated transmissions of the PRACH, in a case where the condition for requesting repeated transmissions of the first PUSCH is not satisfied.

In some embodiments, the processing unit 1110 is further configured to:
determining whether a condition for requesting repeated transmissions of the first PUSCH is satisfied according to a measurement result of a downlink signal.

In some embodiments, the processing unit 1110 is further configured to:
determine that the condition for requesting repeated transmissions of the first PUSCH is satisfied, in a case where the measurement result of the downlink signal satisfies a third threshold; or
determine that the condition for requesting repeated transmissions of the first PUSCH is not satisfied, in a case where the measurement result of the downlink signal does not satisfy the third threshold.

In some embodiments, the number of repeated transmissions of the PRACH is configured by a network device or is predefined.

In some embodiments, in a case where the terminal device adopts repeated transmissions of the PRACH and requests repeated transmissions of the first PUSCH, the PRACH is transmitted via a first PRACH resource, the first PRACH resource belongs to a first PRACH resource set, and the first PRACH resource set is associated with repeated transmissions of the PRACH and repeated transmissions of the first PUSCH.

In some embodiments, in a case where the terminal device adopts repeated transmissions of the PRACH and does not request repeated transmissions of the first PUSCH, the PRACH is transmitted via a second PRACH resource, the second PRACH resource belongs to a second PRACH resource set, and the second PRACH resource set is associated with repeated transmissions of the PRACH.

In some embodiments, in a case where the terminal device does not adopt repeated transmissions of the PRACH and requests repeated transmissions of the first PUSCH, the PRACH is transmitted via a third PRACH resource, the third PRACH resource belongs to a third PRACH resource set, and the third PRACH resource set is associated with repeated transmissions of the first PUSCH.

Optionally, in some embodiments, the communication unit mentioned above may be a communication interface or a transceiver, or an input/output interface of a communication chip or a system on chip. The processing unit mentioned above may be one or more processors.

It should be understood that the terminal device 1100 according to the embodiments of the present application may correspond to the terminal device in the method embodiments of the present application, and the above-mentioned and other operations and/or functions of each unit in the terminal device 1100 are respectively for implementing the corresponding processes of the terminal device in the method 300 shown in FIG. 7, which will not be repeated here for brevity.

FIG. 11 is a schematic block diagram of a network device according to the embodiments of the present application. The network device 1200 in FIG. 11 includes:
a processing unit 1210 configured to determine, according to third information, information carried in a target modulation and coding scheme (MCS) information field and/or whether a random access procedure is applicable to repeated transmissions of a first physical uplink shared channel (PUSCH), where the first PUSCH is used to carry message 3 in the random access procedure, and the third information is related to the repeated transmissions of a physical random access channel (PRACH) in the random access procedure.

In some embodiments, the third information includes a target preamble in repeated transmissions of the PRACH and/or whether the terminal device adopts repeated transmissions of the PRACH.

In some embodiments, the processing unit 1210 is further configured to:
determine, according to whether the terminal device adopts repeated transmissions of the PRACH, the information carried in the target MCS information field and/or whether the terminal device requests repeated transmissions of the first PUSCH.

In some embodiments, the processing unit 1210 is further configured to:
determine that the terminal device requests repeated transmissions of the first PUSCH, in a case where the terminal device adopts repeated transmissions of the PRACH; or
determine that the terminal device does not request repeated transmissions of the first PUSCH, in a case where the terminal device does not adopt repeated transmissions of the PRACH.

In some embodiments, the processing unit 1210 is further configured to:
determine information on the number of repeated transmissions of the first PUSCH carried in the target MCS information field, in a case where the terminal device adopts repeated transmissions of PRACH.

In some embodiments, the processing unit 1210 is further configured to:
determine, according to the target preamble in repeated transmissions of the PRACH, the information carried in the target MCS information field and/or whether the random access procedure is applicable to repeated transmissions of the first PUSCH, in a case where the terminal device adopts repeated transmissions of the PRACH.

In some embodiments, the processing unit 1210 is further configured to:
determine, according to the number of the transmission of the target preamble in repeated transmissions of the PRACH, the information carried in the target MCS information field and/or whether the random access procedure is applicable to repeated transmissions of the first PUSCH.

In some embodiments, the processing unit 1210 is further configured to:
determine that the random access procedure is applicable to repeated transmissions of the first PUSCH, if the number of the transmission of the target preamble in repeated transmissions of the PRACH satisfies a first threshold; or
determine that the random access procedure is not applicable to repeated transmissions of the first PUSCH, if the number of the transmission of the target preamble in repeated transmissions of the PRACH does not satisfy the first threshold.

In some embodiments, the network device further includes:
a communication unit configured to transmit a random access response (RAR) to a terminal device, where the RAR includes first indication information, the first indication information is used to determine the target preamble, and the first indication information is used by the terminal device to determine whether to perform repeated transmissions of the first PUSCH.

In some embodiments, the first indication information is used to indicate at least one of:
index information of the target preamble;
number information of the target preamble in a plurality of preambles, where the plurality of preambles are preambles transmitted in repeated transmissions of the PRACH;
a random access radio network temporary identifier (RA-RNTI) of a physical downlink control channel (PDCCH), where the RA-RNTI is determined according to a resource location on which the target preamble is located, and the PDCCH is used to schedule the RAR;
a PRACH occasion in which the target preamble is located; or
a transmission order number corresponding to a transmission of the target preamble in repeated transmissions of the PRACH.

In some embodiments, the processing unit 1210 is further configured to:
determine information on the number of repeated transmissions of the first PUSCH that is carried in the target MCS information field, if the number of the transmission of the target preamble in repeated transmissions of the PRACH satisfies a first threshold.

In some embodiments, the number of the transmission of the target preamble in repeated transmissions of the PRACH is further used to determine the number of repeated transmissions of the first PUSCH.

In some embodiments, the processing unit 1210 is further configured to:
determine whether the terminal device adopts repeated transmissions of the PRACH according to a PRACH resource used by the terminal device to transmit the PRACH.

In some embodiments, the network device 1200 further includes:
a communication unit configured to transmit first configuration information to the terminal device, where the first configuration information is used to configure a target PRACH resource set, and the target PRACH resource set is associated with repeated transmissions of the PRACH and/or repeated transmissions of a first PUSCH.

In some embodiments, the target PRACH resource set includes at least one of:
a first PRACH resource set, associated with repeated transmissions of the PRACH and repeated transmissions of the first PUSCH;
a second PRACH resource set, associated with repeated transmissions of the PRACH; or
a third PRACH resource set, associated with repeated transmissions of the first PUSCH.

Optionally, in some embodiments, the communication unit mentioned above may be a communication interface or a transceiver, or an input/output interface of a communication chip or a system on chip. The processing unit mentioned above may be one or more processors.

It should be understood that the network device 1200 according to the embodiments of the present application may correspond to the network device in the method embodiments of the present application, and the above-mentioned and other operations and/or functions of each unit in the network device 1200 are respectively for implementing the corresponding processes of the network device in the method 400 shown in FIG. 8, which will not be repeated here for brevity.

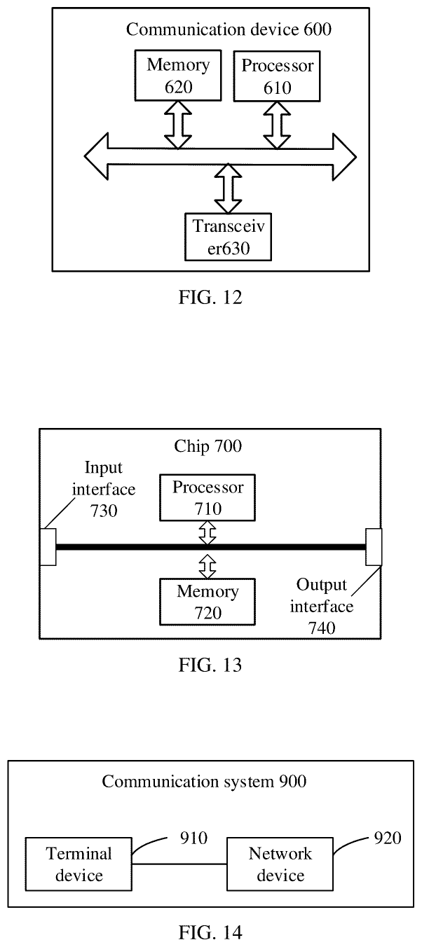

FIG. 12 is a schematic structural diagram of a communication device 600 provided in the embodiments of the present application. The communication device 600 shown in FIG. 12 includes a processor 610, which may invoke and execute a computer program from a memory, to implement the methods in the embodiments of the present application.

Optionally, as shown in FIG. 12, the communication device 600 further includes a memory 620. The processor 610 may invoke and execute a computer program from the memory 620 to implement the method in the embodiments of the present application.

The memory 620 may be a separate device independent from the processor 610, or may be integrated into the processor 610.

Optionally, as shown in FIG. 12, the communication device 600 may further include a transceiver 630, and the processor 610 may control the transceiver 630 to communicate with other devices, and optionally, to transmit information or data to other devices, or receive information or data transmitted by other devices.

The transceiver 630 may include a transmitter and a receiver. The transceiver 630 may further include antenna(s), and the number of antenna(s) may be one or more.

Optionally, the communication device 600 may be the network device in the embodiments of the present application, and the communication device 600 may implement the corresponding procedure implemented by the network device in the various methods of the embodiments of the present application, which will not be repeated here for brevity.

Optionally, the communication device 600 may be the the mobile terminal/terminal device in the embodiments of the present application, and the communication device 600 may implement the corresponding procedure implemented by the mobile terminal/terminal device in the various methods of the embodiments of the present application, which will not be repeated here for brevity.

FIG. 13 is a schematic structural diagram of a chip of the embodiments of the present application. The chip 700 shown in FIG. 13 includes a processor 710, and the processor 710 may invoke and execute a computer program from a memory to implement the method in the embodiments of the present application.

Optionally, as shown in FIG. 13, the chip 700 may further include a memory 720. The processor 710 may invoke and execute a computer program from the memory 720 to implement the method in the embodiments of the present application.

The memory 720 may be a separate device independent from the processor 710, or may be integrated into the processor 710.

Optionally, the chip 700 may further include an input interface 730. The processor 710 may control the input interface 730 to communicate with other devices or chips, and optionally, the input interface 730 may acquire information or data sent by other devices or chips.

Optionally, the chip 700 may further include an output interface 740. The processor 710 may control the output interface 740 to communicate with other devices or chips, and optionally, the output interface 740 may output information or data to other devices or chips.

Optionally, the chip may be applied to the network device in the embodiments of the present application, and the chip may implement the corresponding procedure implemented by the network device in the various methods of the embodiments of the present application, which will not be repeated here for brevity.

Optionally, the chip may be applied to the mobile terminal/terminal device in the embodiments of the present application, and the chip may implement the corresponding procedure implemented by the mobile terminal/terminal device in the various methods of the embodiments of the present application, which will not be repeated here for brevity.

It should be understood that the chip mentioned in the embodiments of the present application may also be called a system on chip, a system chip, a chip system or a system-on-chip chip, etc.

FIG. 14 is a schematic block diagram of a communication system 900 provided in the embodiments of the present application. As shown in FIG. 14, the communication system 900 includes a terminal device 910 and a network device 920.

The terminal device 910 may be used to implement the corresponding functions implemented by the terminal device in the above-mentioned methods, and the network device 920 may be used to implement the corresponding functions implemented by the network device in the above-mentioned methods, which will not be repeated here for brevity.

It should be understood that the processor in the embodiments of the present application may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present application may be implemented or performed. A general-purpose processor may be a microprocessor, or the processor may also be any conventional processor, etc. The steps of the method disclosed in combination with the embodiments of the present application may be directly embodied as being performed and completed by a hardware decoding processor, or by using a combination of hardware and software modules in the decoding processor. The software module may be located in the mature non-transitory storage medium in the art such as the random memory, the flash memory, the read-only memory, the programmable read-only memory or electrically erasable programmable memory, the register. The non-transitory storage medium is located in the memory, and the processor reads the information in the memory and completes the steps of the above methods in combination with its hardware.

It may be understood that, the memory in the embodiments of the present application may be a volatile memory or a non-volatile memory, or may include both volatile and non-volatile memories. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present application may also be a static random access memory (static RAM, SRAM), a dynamic random access memory (dynamic RAM, DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM). That is, the memory in the embodiments of the present application is intended to include, but not limited to, these and any other suitable types of memories.

The embodiments of the present application further provide a non-transitory computer readable storage medium for storing a computer program.

Optionally, the non-transitory computer readable storage medium may be applied to the network device in the embodiments of the present application, and the computer program causes a computer to perform the corresponding procedure implemented by the network device in the various methods of the embodiments of the present application, which will not be repeated here for brevity.

Optionally, the non-transitory computer readable storage medium may be applied to the mobile terminal/terminal device in the embodiments of the present application, and the computer program causes a computer to perform the corresponding procedure implemented by the mobile terminal/terminal device in various methods of the embodiments of the present application, which will not be repeated here for brevity.

The embodiments of the present application further provide a computer program product including a computer program instruction.

Optionally, the computer program product may be applied to the network device in the embodiments of the present application, and the computer program instruction causes a computer to perform the corresponding procedure implemented by the network device in the various methods of the embodiments of the present application, which will not be repeated here for brevity.

Optionally, the computer program product may be applied to the fi mobile terminal/terminal device in the embodiments of the present application, and the computer program instruction causes a computer to perform the corresponding procedure implemented by the mobile terminal/terminal device in various methods of the embodiments of the present application, which will not be repeated here for brevity.

The embodiments of the present application further provide a computer program.

Optionally, the computer program may be applied to network device in the embodiments of the present application, the computer program when being executed on a computer, causes the computer to perform the corresponding procedure implemented by the network device in various methods of the embodiments of the present application, which will not be repeated here for brevity.

Optionally, the computer program may be applied to the mobile terminal/terminal device in the embodiments of the present application, the computer program when being executed on a computer, causes the computer to perform the corresponding procedure implemented by the mobile terminal/terminal device in various methods of the embodiments of the present application, which will not be repeated here for brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present application.

It may be clearly understood by those skilled in the art that, for convenience and brevity of the description, the specific working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

If the described functions are implemented in the form of a software functional unit and sold or used as an independent product, they may be stored in a non-transitory computer readable storage medium. Based on this understanding, the technical solution of the present application essentially, or a part of the technical solution that contributes to the prior art, or a part of the technical solution, may be embodied in the form of a software product, and the computer software product is stored in a non-transitory storage medium, and includes a plurality of instructions for enabling a computer device (which may be a personal computer, a server, or a network device, etc.) to perform all or some of steps of the methods described in the various embodiments of the present application. And, the non-transitory storage medium mentioned above includes a USB flash drive (U disk), a mobile hard disk, a read-only memory (ROM), a random access memory (RAM), a diskette, or an optical disk, and various mediums that may store program codes.

The above content is only implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A wireless communication method, comprising:
determining, by a terminal device according to first information, an interpretation mode for a target modulation and coding scheme (MCS) information field and/or whether a random access procedure is applicable to repeated transmissions of a first physical uplink shared channel (PUSCH), wherein the first PUSCH is used to carry message 3 in the random access procedure, and the first information is related to repeated transmissions of a physical random access channel (PRACH) in the random access procedure.

2. The method according to claim 1, wherein the first information comprises a random access response (RAR) in the random access procedure and whether the random access procedure is applicable to repeated transmissions of the PRACH.

3. The method according to claim 2, wherein determining, by the terminal device according to the first information, the interpretation mode for the target MCS information field and/or whether the random access procedure is applicable to repeated transmissions of the first PUSCH comprises:
determining, by the terminal device according to the first information, the interpretation mode for the target MCS information field and/or whether to request repeated transmissions of the first PUSCH.

4. The method according to claim 3, wherein determining, by the terminal device according to the first information, whether to request repeated transmissions of the first PUSCH comprises: determining to request repeated transmissions of the first PUSCH, in a case where the random access procedure is applicable to repeated transmissions of the PRACH; or
determining not to request repeated transmissions of the first PUSCH, in a case where the random access procedure is not applicable to repeated transmissions of the PRACH.

5. The method according to claim 3, wherein determining, by the terminal device according to the first information, the interpretation mode for the target MCS information field comprises:
determining the number of repeated transmissions of the first PUSCH according to the target MCS information field, in a case where the random access procedure is applicable to repeated transmissions of the PRACH.

6. The method according to claim 2, wherein determining, by the terminal device according to the first information, the interpretation mode for the target MCS information field and/or whether the random access procedure is applicable to repeated transmissions of the first PUSCH comprises:
determining, according to the RAR, the interpretation mode for the target MCS information field and/or whether to perform repeated transmissions of the first PUSCH, in a case where the random access procedure is applicable to repeated transmissions of the PRACH.

7. The method according to claim 1, further comprising:
determining whether the random access procedure is applicable to repeated transmissions of the PRACH according to a measurement result of a downlink signal; wherein
determining whether the random access procedure is applicable to repeated transmissions of the PRACH according to the measurement result of the downlink signal comprises:
determining that the random access procedure is applicable to repeated transmissions of the PRACH, in a case where the measurement result of the downlink signal satisfies a second threshold; or
determining that the random access procedure is not applicable to repeated transmissions of the PRACH, in a case where the measurement result of the downlink signal does not satisfy the second threshold.

8. The method according to claim 1, wherein the method further comprises:
determining the number of repeated transmissions of the PRACH according to a measurement result of a downlink signal and a plurality of measurement result ranges, wherein the plurality of measurement result ranges respectively correspond to different quantities of repeated transmissions of the PRACH, and the plurality of measurement result ranges are determined according to a plurality of thresholds.

9. The method according to claim 1, wherein in a case where the terminal device adopts repeated transmissions of the PRACH and requests repeated transmissions of the first PUSCH, the PRACH is transmitted via a first PRACH resource, the first PRACH resource belongs to a first PRACH resource set, and the first PRACH resource set is associated with repeated transmissions of the PRACH and repeated transmissions of the first PUSCH;
or
in a case where the terminal device adopts repeated transmissions of the PRACH and does not request repeated transmissions of the first PUSCH, the PRACH is transmitted via a second PRACH resource, the second PRACH resource belongs to a second PRACH resource set, and the second PRACH resource set is associated with repeated transmissions of the PRACH;
or
in a case where the terminal device does not adopt repeated transmissions of the PRACH and requests repeated transmissions of the first PUSCH, the PRACH is transmitted via a third PRACH resource, the third PRACH resource belongs to a third PRACH resource set, and the third PRACH resource set is associated with repeated transmissions of the first PUSCH.

10. A wireless communication method, comprising:
determining, by a network device according to third information, information carried in a target modulation and coding scheme (MCS) information field and/or whether a random access procedure is applicable to repeated transmissions of a first physical uplink shared channel (PUSCH), wherein the first PUSCH is used to carry message 3 in the random access procedure, and the third information is related to repeated transmissions of a physical random access channel (PRACH) in the random access procedure.

11. The method according to claim 10, wherein the third information comprises a target preamble transmitted in repeated transmissions of the PRACH and/or whether a terminal device adopts repeated transmissions of the PRACH.

12. The method according to claim 11, wherein determining, by the network device according to the third information, the information carried in the target MCS information field and/or whether the random access procedure is applicable to repeated transmissions of the first PUSCH comprises:
determining, according to whether the terminal device adopts repeated transmissions of the PRACH, the information carried in the target MCS information field and/or whether the terminal device requests repeated transmissions of the first PUSCH.

13. The method according to claim 12, wherein determining, according to whether the terminal device adopts repeated transmissions of the PRACH, whether the terminal device requests repeated transmissions of the first PUSCH comprises:
determining that the terminal device requests repeated transmissions of the first PUSCH, in a case where the terminal device adopts repeated transmissions of the PRACH; or
determining that the terminal device does not request repeated transmissions of the first PUSCH, in a case where the terminal device does not adopt repeated transmissions of the PRACH.

14. The method according to claim 12, wherein determining, according to whether the terminal device adopts repeated transmissions of the PRACH, the information carried in the target MCS information field comprises:
determining information on the number of repeated transmissions of the first PUSCH carried in the target MCS information field, in a case where the terminal device adopts repeated transmissions of PRACH.

15. The method according to claim 11, wherein determining, by the network device according to the third information, the information carried in the target MCS information field and/or whether the random access procedure is applicable to repeated transmissions of the first PUSCH comprises:
determining, according to the target preamble transmitted in repeated transmissions of the PRACH, the information carried in the target MCS information field and/or whether the random access procedure is applicable to repeated transmissions of the first PUSCH, in a case where the terminal device adopts repeated transmissions of the PRACH.

16. The method according to claim 10, wherein the method further comprises:
transmitting, by the network device, first configuration information to the terminal device, wherein the first configuration information is used to configure a target PRACH resource set, and the target PRACH resource set is associated with repeated transmissions of the PRACH and/or repeated transmissions of the first PUSCH; wherein
the target PRACH resource set comprises at least one of:
a first PRACH resource set, associated with repeated transmissions of the PRACH and repeated transmissions of the first PUSCH;
a second PRACH resource set, associated with repeated transmissions of the PRACH; or
a third PRACH resource set, associated with repeated transmissions of the first PUSCH.

17. A terminal device, comprising a processor and a memory, wherein the memory is configured to store a computer program, and the processor is configured to invoke and execute the computer program stored in the memory to cause the terminal device to perform;
determining, according to first information, an interpretation mode for a target modulation and coding scheme (MCS) information field and/or whether a random access procedure is applicable to repeated transmissions of a first physical uplink shared channel (PUSCH), wherein the first PUSCH is used to carry message 3 in the random access procedure, and the first information is related to repeated transmissions of a physical random access channel (PRACH) in the random access procedure.

18. The terminal device according to claim 17, wherein the first information comprises a random access response (RAR) in the random access procedure and whether the random access procedure is applicable to repeated transmissions of the PRACH.

19. The terminal device according to claim 18, wherein determining according to the first information, the interpretation mode for the target MCS information field and/or whether the random access procedure is applicable to repeated transmissions of the first PUSCH comprises:
determining according to the first information, the interpretation mode for the target MCS information field and/or whether to request repeated transmissions of the first PUSCH.

20. A network device, comprising a processor and a memory, wherein the memory is configured to store a computer program, and the processor is configured to invoke and execute the computer program stored in the memory to perform the method according to claim 10.
